(19) United States
(12) Patent Application Publication
(10) Pub. No.: US 2013/0176524 A1
(43) Pub. Date: Jul. 11, 2013

(54) PIXEL STRUCTURE FOR LIQUID CRYSTAL DISPLAY DEVICE

(71) Applicant: AU Optronics Corporation, Hsinchu (TW)

(72) Inventors: Kuan-Yu Chen, Hsinchu (TW); Tien-Lun Ting, Hsinchu (TW); Chien-Huang Liao, Hsinchu (TW)

(73) Assignee: AU OPTRONICS CORPORATION, Hsinchu (TW)

(21) Appl. No.: 13/713,693

(22) Filed: Dec. 13, 2012

Related U.S. Application Data
(63) Continuation-in-part of application No. 13/346,899, filed on Jan. 10, 2012.

(30) Foreign Application Priority Data
Aug. 9, 2012 (TW) 101128791

(51) Int. Cl. G02F 1/1343

(52) U.S. Cl. CPC G02F 1/134336
USPC 349/146; 349/143

(57) ABSTRACT

In one aspect of the invention, a liquid crystal display device includes a pixel matrix having a plurality of pixels. Each pixel includes a first pixel electrode having a plurality of first pixel electrode stripes and a second pixel electrode having a plurality of second pixel electrode stripes. The first pixel electrode stripes and the second pixel electrode stripes are alternately placed to define a plurality of pitches therebetween. Each pitch is defined between two adjacent first pixel electrode and second pixel electrode stripes, and has a width. In one embodiment, the width of at least one of the pitches is different from that of the other pitches. In another embodiment, the width of each pitch is variable along the adjacent first pixel electrode and second pixel electrode stripes.

### CROSS-REFERENCE TO RELATED PATENT APPLICATIONS

This application is a continuation-in-part application of U.S. patent application Ser. No. 13/346,899, filed Jan. 10, 2012, entitled “PIXEL STRUCTURE FOR LIQUID CRYSTAL DISPLAY DEVICE,” by Kuan-Yu Chen, Tien-Lun Ting, Chien-Huang Liao, which is incorporated herein in its entirety by reference.

This application also claims priority under 35 U.S.C. §119(a) on Patent Application No. 101128791 filed in Taiwan (R.O.C) on Aug. 9, 2012, entitled “PIXEL STRUCTURE FOR LIQUID CRYSTAL DISPLAY DEVICE,” by Kuan-Yu Chen, Tien-Lun Ting, and Chien-Huang Liao, which is incorporated herein in its entirety by reference.

### FIELD OF THE INVENTION

The present invention generally relates to a liquid crystal display (LCD) device, and more particularly to pixel structures with variable pitch widths between the first and second pixel electrodes of the pixels of an LCD device.

### BACKGROUND OF THE INVENTION

A liquid crystal display (LCD) is commonly used as a display device because of its capability of displaying images with good quality while using little power. Generally, several different active matrix technologies are utilized in LCD devices. For example, the twisted nematic (TN) displays contain liquid crystals that twist and untwist at varying degrees to allow light to pass through. However, applications of the TN displays are limited to those with relatively low data rates because of long relaxation time of the liquid crystal cells, and the TN technology has a limited range of viewing angles.

Other matrix technologies, such as in plane switching (IPS) or vertical alignment (VA) structures, may provide more flexible displaying properties. In VA displays, when no voltage is applied, the liquid crystals remain perpendicular to the substrates creating a black display between crossed polarizers, and when voltage is applied, the liquid crystals shift to a tilted position allowing light to pass through and create a gray-scale display. In the IPS technology, opposite electrodes (common and pixel electrodes) applying electrical fields to the liquid crystal cells are provided on the same substrate so that the liquid crystals can be reoriented (switched) in the same plane. The VA displays have the advantage of high contrast ratio and high response speed of the LCD panel, and the IPS structures lead to little color difference in big and oblique viewing angles.

The vertical alignment in-plane switching (VA-IPS) technology is a combination of both the VA and IPS structures, where the common and pixel electrodes are provided on the same substrate and the liquid crystals remain perpendicular to the substrates when no voltage is applied. However, color distortion in the big and oblique viewing angles (i.e. the color washout effect) is a problem of the VA-IPS displays.

A similar technology to the VA-IPS displays exists in the transverse bend alignment (TBA) structures. In the TBA displays, in addition to the common and pixel electrodes provided on the same substrate in the VA-IPS structure, a counter electrode electrically connected to the common electrode is provided on the opposite substrate so that the counter electrode and the common electrode would be applied the same voltage to form the electrical field to the liquid crystal cells. The liquid crystals in the TBA displays remain perpendicular to the substrates when no voltage is applied, which is similar to the VA-IPS displays. Similarly, the TBA technology has the similar color washout problem in the big and oblique viewing angles.

Generally, a method to solve the color washout problem is to increase the number of the pitches (the distance between the pixel and common electrodes) in a pixel. For example, FIG. 13 shows a diagram of the gray level gamma curves of the LCD devices with different numbers of pitches in a pixel. When the oblique viewing angle increases, as shown by the curves B1/B2 and C1/C2 in FIG. 13, the LCD device with 14 pitches in a pixel has a smoother gamma curve (and thus better color washout performance) than the LCD device with only 4 pitches in a pixel. However, with the trend of downsizing of the LCD devices, the size of the pixels is also reduced, thus the number of the pitches that can be provided in a pixel is also limited.

Therefore, a heretofore unaddressed need exists in the art to address the aforementioned deficiencies and inadequacies.

### SUMMARY OF THE INVENTION

The present invention, in one aspect, relates to a liquid crystal display device. In one embodiment, the liquid crystal display device includes a first substrate and a second substrate positioned apart to define a cell gap therebetween, a liquid crystal layer positioned in the cell gap between the first substrate and the second substrate, defining a plurality of liquid crystal cells, and a pixel matrix having a plurality of pixels formed on the first substrate. Each pixel is associated with a corresponding liquid crystal cell, and includes a first pixel electrode having a plurality of first pixel electrode stripes and a second pixel electrode having a plurality of second pixel electrode stripes. The plurality of first pixel electrode stripes and the plurality of second pixel electrode stripes are alternately placed to define a plurality of pitches therebetween, where each pitch is defined by two adjacent first pixel electrode and second pixel electrode stripes and has a width that is variable along the adjacent first pixel electrode and second pixel electrode stripes. A reference line is located between the two adjacent first pixel electrode stripe and second pixel electrode stripe so that the two adjacent first pixel electrode stripe and second pixel electrode stripe are symmetric with respect to the reference line. In one embodiment, each pixel may further include a counter electrode formed on the second substrate, and the counter electrode is electrically connected to the second pixel electrode. In another embodiment, the counter electrode may be electrically connected to the first electrode. In yet another embodiment, an AC voltage or a DC voltage may be applied to the counter electrode.

In one embodiment, the first pixel electrode further comprises a ridge portion, where each first pixel electrode stripe is extended from the ridge portion such that each first pixel electrode stripe and the ridge portion define a first angle, α1, therebetween. The second pixel electrode further comprises a top portion and a bottom portion spaced-apart formed being parallel to the ridge portion of the first pixel electrode, where each second pixel electrode stripe is extended from one of the top and bottom portions towards the ridge portion of the first pixel electrode such that each second pixel electrode stripe and the ridge portion of the first pixel electrode define a second angle, α2, therebetween. The second angle α2 is substantially different from the first angle α1. In one embodiment, the top and bottom portions and the plurality of second pixel electrode stripes of the second pixel electrode and the plurality of first pixel electrode stripes of the first pixel electrode are placed symmetrically to the ridge portion of the first pixel electrode.

In another embodiment, the first pixel electrode further comprises a side portion and a ridge portion perpendicularly extended from the side portion, where each first pixel electrode stripe is extended from one of the side portion and the ridge portion such that each first pixel electrode stripe and the ridge portion define a first angle, α1, therebetween. The second pixel electrode further comprises a side portion having a first end and an opposite, second end, a top portion and a bottom portion perpendicularly extended from the first and second ends, respectively, of the side portion that is aligned parallel to the side portion of the first pixel electrode. Each second pixel electrode stripe is extended from one of the side, top and bottom portions towards the ridge portion of the first pixel electrode such that each second pixel electrode stripe and the ridge portion of the first pixel electrode define a second angle, α2, therebetween. The second angle α2 is substantially different from the first angle α1. In one embodiment, the side, top and bottom portions and the plurality of second pixel electrode stripes of the second pixel electrode, and the side portion and the plurality of first pixel electrode stripes of the first pixel electrode are placed symmetrically to the ridge portion of the first pixel electrode.

In one embodiment, the width of each pitch varies continuously along the adjacent first pixel electrode and second pixel electrode stripes. In another embodiment, the width of each pitch varies discontinuously along the adjacent first pixel electrode and second pixel electrode stripes. In one embodiment, the width of at least one of the plurality of pitches is different from that of the other pitches.

In one embodiment, each first pixel electrode stripe comprises a straight stripe, a curved stripe, a slant stripe or a step-like stripe. Each second pixel electrode stripe comprises a straight stripe, a curved stripe, a slant stripe or a step-like stripe.

Further, the liquid crystal display device includes a plurality of gate lines and signal lines electrically connected to the pixels correspondingly, where each first pixel electrode stripe and one of the gate lines form a first angle, α1, and each second pixel electrode stripe and the one of the gate lines form a second angle, α2, where the second angle α2 is substantially different from the first angle α1.

In one embodiment, each of the first and second pixel electrode stripes is divided into a plurality of segments along the reference line, and the width of each pitch varies differently in each of the plurality of segments. In a further embodiment, two adjacent first pixel electrode stripe and second pixel electrode stripe are symmetric.

In another aspect of the present invention, a liquid crystal display device includes a first substrate and a second substrate positioned apart to define a cell gap therebetween, a liquid crystal layer positioned in the cell gap between the first substrate and the second substrate, defining a plurality of liquid crystal cells, and a pixel matrix having a plurality of pixels formed on the first substrate. Each pixel is associated with a corresponding liquid crystal cell, and includes a first pixel electrode having a plurality of first pixel electrode stripes and a second pixel electrode having a plurality of second pixel electrode stripes. The plurality of first pixel electrode stripes and the plurality of second pixel electrode stripes are alternately placed to define a plurality of pitches therebetween, where each pitch is defined by the adjacent first pixel electrode stripe and second pixel electrode stripe and has a width, and the width of at least one of the pitches is different from the width of the other pitches. In one embodiment, each pixel may further include a counter electrode formed on the second substrate. The counter electrode in one embodiment is electrically connected to the second pixel electrode. In another embodiment, the counter electrode may be electrically connected to the first pixel electrode. In one embodiment, an AC or DC voltage may be applied to the counter electrode.

In one embodiment, the first pixel electrode further comprises a ridge portion, where each first pixel electrode stripe is extended from the ridge portion such that each first pixel electrode stripe and the ridge portion define a first angle, α1, therebetween. The second pixel electrode further comprises a top portion and a bottom portion spaced-apart formed being parallel to the ridge portion of the first pixel electrode, where each second pixel electrode stripe is extended from one of the top and bottom portions towards the ridge portion of the first pixel electrode such that each second pixel electrode stripe and the ridge portion of the first pixel electrode define a second angle, α2, therebetween. The second angle α2 is same as or substantially different from the first angle α1. In one embodiment, the top and bottom portions and the plurality of second pixel electrode stripes of the second pixel electrode and the plurality of first pixel electrode stripes of the first pixel electrode are placed in the two side of the ridge portion of the first pixel electrode. In one embodiment, the top and bottom portions and the plurality of second pixel electrode stripes of the second pixel electrode and the plurality of first pixel electrode stripes of the first pixel electrode are placed symmetrically to the ridge portion of the first pixel electrode.

In another embodiment, the first pixel electrode further comprises a side portion and a ridge portion perpendicularly extended from the side portion, where each first pixel electrode stripe is extended from one of the side portion and the ridge portion such that each first pixel electrode stripe and the ridge portion define a first angle, α1, therebetween. The second pixel electrode further comprises a side portion having a first end and a opposite, second end, a top portion and a bottom portion perpendicularly extended from the first and second ends, respectively, of the side portion that is aligned parallel to the side portion of the first pixel electrode. Each second pixel electrode stripe is extended from one of the side, top and bottom portions towards the ridge portion of the first pixel electrode such that each second pixel electrode stripe and the ridge portion of the first pixel electrode define a second angle, α2, therebetween. The second angle α2 is same as or substantially different from the first angle α1. In one embodiment, the side, top and bottom portions and the plurality of second pixel electrode stripes of the second pixel electrode, and the side portion and the plurality of first pixel electrode stripes of the first pixel electrode are placed in the two sides of, preferably, symmetrically to, the ridge portion of the first pixel electrode.

In one embodiment, the width of each pitch varies continuously along the adjacent first pixel electrode and second pixel electrode stripes. In another embodiment, the width of each pitch varies discontinuously along the adjacent first pixel electrode and second pixel electrode stripes. In one embodiment, the width of each pitch is variable along the adjacent first pixel electrode stripe and second pixel electrode stripe.

In one embodiment, each first pixel electrode stripe comprises a straight stripe, a curved stripe, a slant stripe or a step-like stripe, and each second pixel electrode stripe comprises a straight stripe, a curved stripe, a slant stripe or a step-like stripe. In another embodiment, each of the first and second pixel electrodes is divided into a first segment, a second segment, and a slant portion connected between the first segment and the second segment.

Further, the liquid crystal display device includes a plurality of gate lines and signal lines electrically connected to the pixels correspondingly. Each first pixel electrode stripe and one of the gate lines form a first angle, α1, and each second pixel electrode stripe and the one of the gate lines form a second angle, α2, where the second angle α2 is substantially different from the first angle α1.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1A shows schematically a partial cross-sectional view of an LCD device when no voltage is applied according to one embodiment of the present invention;

FIG. 1B shows schematically a partial cross-sectional view of an LCD device when voltage is applied according to one embodiment of the present invention;

FIG. 2 shows schematically a plain view of the electrode structure of an LCD device according to one embodiment of the present invention;

FIG. 3A shows schematically a plain view of the electrode structure of an LCD device according to one embodiment of the present invention;

FIG. 3B shows schematically an enlarged partial view of a pitch between the two electrode stripes in FIG. 3A;

FIG. 4 shows schematically a plain view of the electrode structure of an LCD device according to another embodiment of the present invention;

FIG. 5A shows schematically a plain view of the electrode structure of an LCD device according to one embodiment of the present invention;

FIG. 5B shows schematically a plain view of the electrode structure of an LCD device according to another embodiment of the present invention;

FIG. 6A shows schematically a plain view of the electrode structure of an LCD device according to one embodiment of the present invention;

FIG. 6B shows schematically a plain view of the electrode structure of an LCD device according to another embodiment of the present invention;

FIG. 7A shows schematically a plain view of the electrode structure of an LCD device according to one embodiment of the present invention;

FIG. 7B shows schematically a plain view of the electrode structure of an LCD device according to another embodiment of the present invention;

FIG. 8A shows schematically a plain view of the horizontal electrode structure of an LCD device according to one embodiment of the present invention;

FIG. 8B shows schematically a plain view of the horizontal electrode structure of an LCD device according to another embodiment of the present invention;

FIG. 9 shows schematically a partial plain view of the electrode structure of an LCD device according to another embodiment of the present invention;

FIG. 10A shows schematically a partial cross-sectional view of an LCD device when no voltage is applied according to a further embodiment of the present invention;

FIG. 10B shows schematically a partial cross-sectional view of an LCD device when voltage is applied according to a further embodiment of the present invention;

FIG. 11A shows schematically a plain view of the vertical pixel arrangement of an LCD device according to one embodiment of the present invention;

FIG. 11B shows schematically a plain view of a pixel of the LCD device shown in FIG. 11A;

FIG. 12A shows schematically a plain view of the horizontal pixel arrangement of an LCD device according to another embodiment of the present invention;

FIG. 12B shows schematically a plain view of a pixel of the LCD device shown in FIG. 12A; and

FIG. 13 shows schematically a diagram of the gray level gamma curves of LCD devices with different numbers of pitches in a pixel.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” or “includes” and/or “including” or “has” and/or “having” when used herein, specify the presence of stated features, regions, integers, steps, operations, elements, parts, segments and/or components, but do not preclude the presence or addition of one or more other features, regions, integers, steps, operations, elements, segments, components, and/or groups thereof

It will be understood that, although the terms first, second, third etc. may be used herein to describe various elements, components, regions, layers and/or sections, these elements, components, regions, layers, segments and/or sections should not be limited by these terms. These terms are only used to distinguish one element, component, region, layer, segment or section from another element, component, region, layer, segment or section. Thus, a first element, component, region, layer, segment or section discussed below could be termed a second element, component, region, layer, segment or section without departing from the teachings of the present invention.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

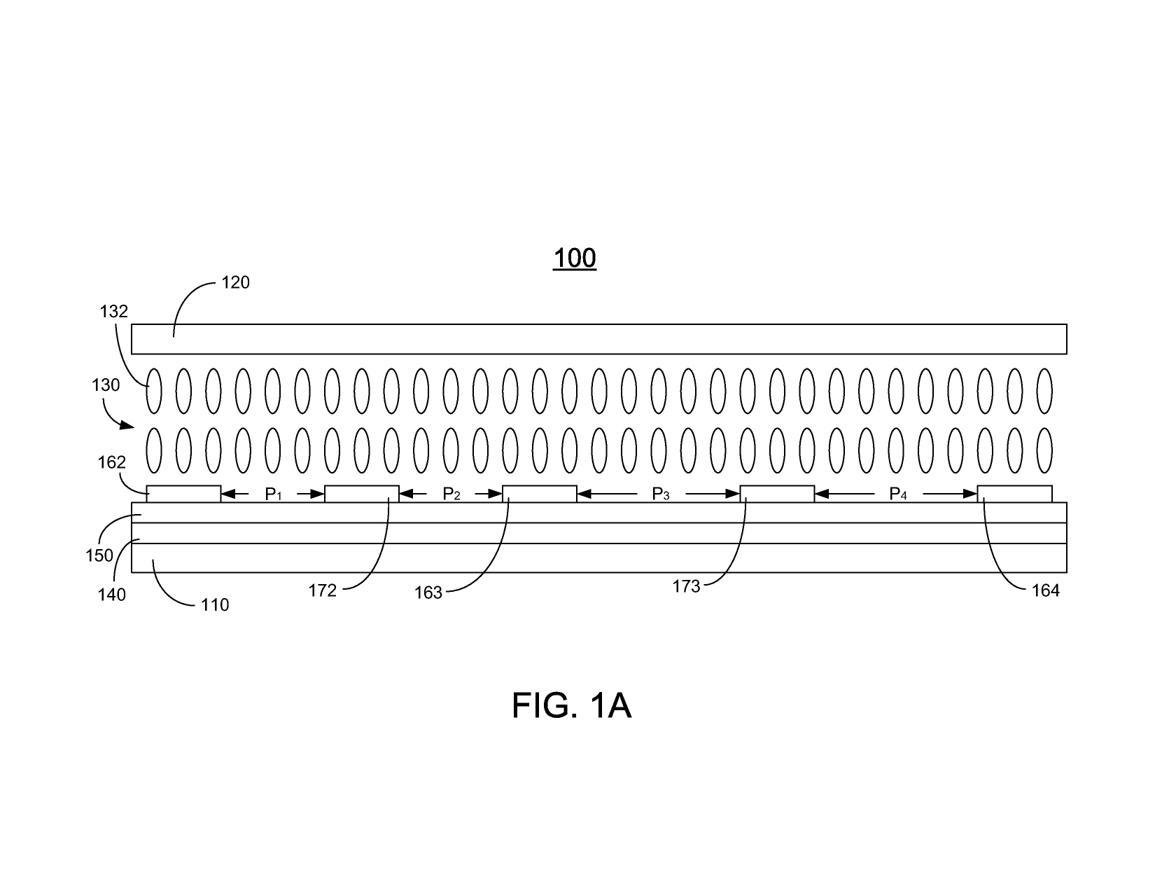

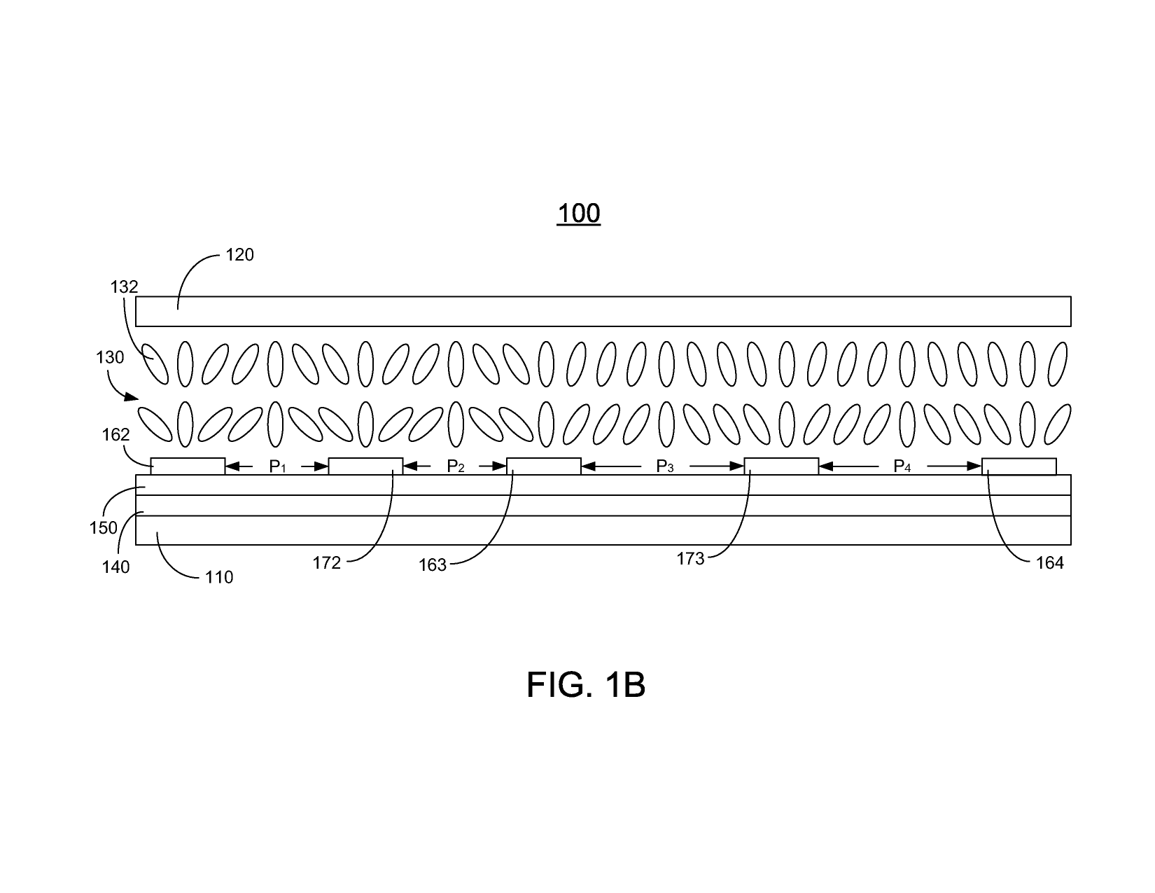

The description will be made as to the embodiments of the present invention in conjunction with the accompanying drawings in FIGS. 1-12. In accordance with the purposes of this invention, as embodied and broadly described herein, this invention, in one aspect, relates to a liquid crystal display (LCD) device utilizing the VA-IPS or TBA technologies, by designing pixel structures with variable pitch widths between the first and second pixel electrodes of the pixels.

FIGS. 1A and 1B show schematically two partial cross-sectional views of an LCD device 100 according to one embodiment of the present invention, where FIG. 1A shows a liquid crystal orientation of the LCD device 100 when no voltage is applied and FIG. 1B shows the liquid crystal orientation of the LCD device 100 when a voltage is applied. According to the embodiment, the LCD device 100 utilizes the VA-IPS technology and has a first substrate 110 and a second substrate 120 positioned apart to define a cell gap therebetween, a liquid crystal layer 130 positioned in the cell gap between the first substrate 110 and the second substrate 120, defining a plurality of liquid crystal cells, and a pixel matrix having a plurality of pixels formed on the first substrate 110. Each pixel is associated with a corresponding liquid crystal cell, and includes a first pixel electrode having a plurality of first pixel electrode stripes 172 and 173 and a second pixel electrode having a plurality of second pixel electrode stripes 162, 163 and 164. As shown in FIGS. 1A and 1B, the cross-sectional view is taken along a line substantially crossing the second pixel electrode stripes and the first pixel electrode stripes in order to better illustrate the structure of the LCD device 100, and for the purpose of showing the structure in details, only a part of the cross-section of one pixel of the LCD device 100 is shown.

As shown in FIG. 1A, the first substrate 110 and the second substrate 120 are positioned apart to define a cell gap therebetween. The liquid crystal layer 130 is positioned in the cell gap between the first substrate 110 and the second substrate 120, defining a plurality of liquid crystal cells (only one liquid crystal cell is shown in the figure), and each liquid crystal cell includes a plurality of liquid crystals 132. Also, on the first substrate 110, a gate nitride layer 140 and a passivation layer 150 are respectively formed. As shown in FIG. 1A, all of the liquid crystals have the orientation in perpendicular to the first substrate 110 and the second substrate 120 because no voltage is applied to the LCD device 100.

According to the present invention, each pixel is associated with a corresponding liquid crystal cell, and includes a first pixel electrode having a plurality of first pixel electrode stripes and a second pixel electrode having a plurality of second pixel electrode stripes. FIG. 1A shows the second pixel electrode stripes 162, 163 and 164 of the second pixel electrode (symbolized as Vcom) of the pixel and the first pixel electrode stripes 172 and 173 of the first pixel electrode (symbolized as Vpixel) of the pixel. The plurality of first pixel electrode stripes 172 and 173 and the plurality of second pixel electrode stripes 162, 163 and 164 are alternately placed so that the first pixel electrode stripe 172 is positioned between the second pixel electrode stripes 162 and 163, and the first pixel electrode stripe 173 is positioned between the second pixel electrode stripes 163 and 164. Also, a plurality of pitches P₁, P₂, P₃ and P₄ is defined between the plurality of first pixel electrode stripes 172 and 173 and the plurality of second pixel electrode stripes 162, 163 and 164. Specifically, the pitch P₁ is defined by the adjacent first pixel electrode stripe 172 and second pixel electrode stripe 162, the pitch P₂ is defined by the adjacent first pixel electrode stripe 172 and second pixel electrode stripe 163, the pitch P₃ is defined by the adjacent first pixel electrode stripe 173 and second pixel electrode stripe 163, and the pitch P₄ is defined by the adjacent first pixel electrode stripe 173 and second pixel electrode stripe 164. Further, each pitch has a width, and the pitches P₁, P₂, P₃ and P₄ are not all in the same width. Specifically, the pitches P₃ and P₄ have a width larger than that of the pitches P₁ and P₂.

FIG. 1B shows the same LCD device 100 in FIG. 1A when a voltage is applied, and thus all the elements are numerated with the same numerals. When a voltage is applied to the LCD device 100, a plurality of electrical fields is generated by the plurality of first pixel electrode stripes 172 and 173 and the plurality of second pixel electrode stripes 162, 163 and 164, accordingly, the liquid crystals 132 in the liquid crystal layer 130 shift to a tilted position in response to the electrical fields. The range of the electrical fields between the electrode stripes would be different because of the difference of the widths of the pitches P₃ and P₄ and the widths of the pitches P₁ and P₂, as shown in FIG. 1B.

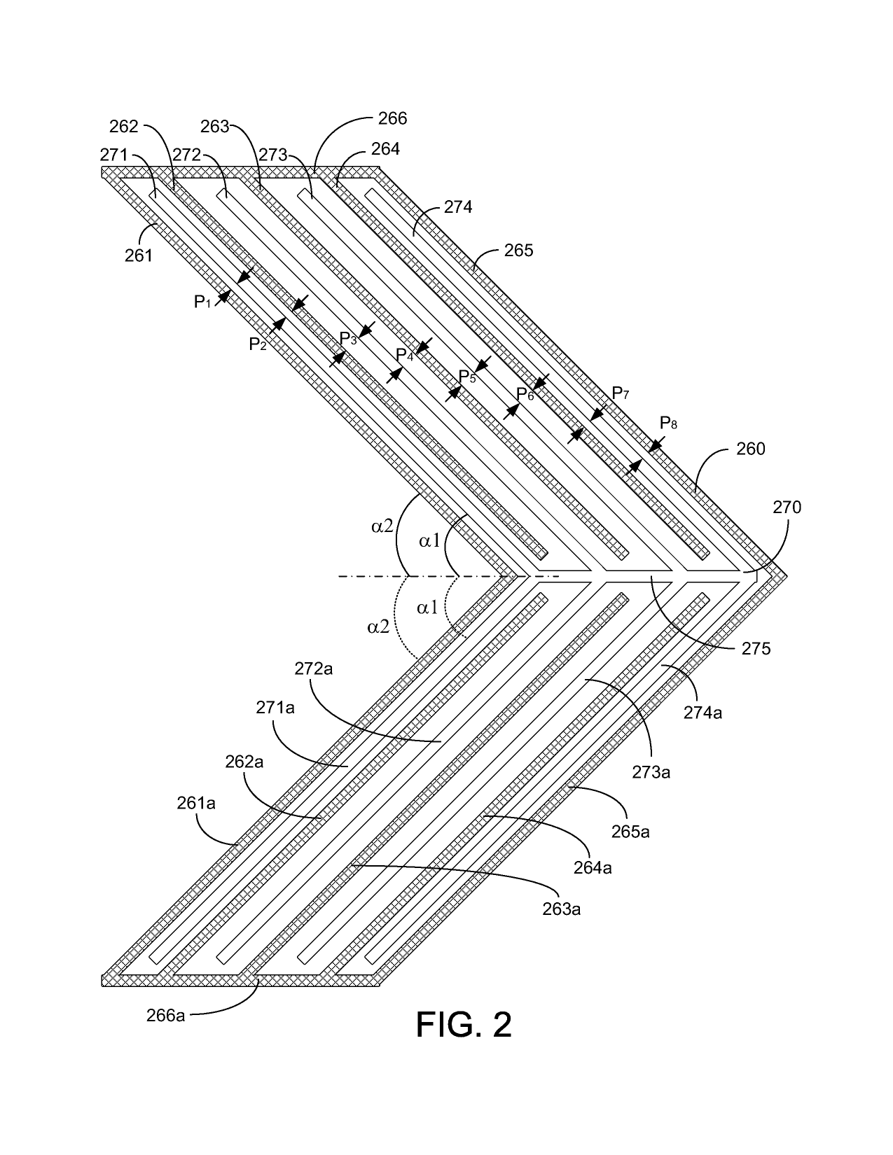

The variation of the widths of the pitches between the electrodes can be realized in a variety of embodiments. For example, FIGS. 2-8B shows schematically a plain view of the electrode structures of the LCD device according to different embodiments of the present invention. As shown in FIG. 2, the first pixel electrode 270 has a plurality of first pixel electrode stripes, for example, 271-274 and 271a-274a, and a ridge portion (or a middle portion) 275. In this exemplary embodiment, the first pixel electrode stripes 271-274 and 271a-274a are symmetrically extended from the ridge portion 275, but not limited thereto, such that each first pixel electrode stripe 271, 272, 273, 274, 271a, 272a, 273a or 274a and the ridge portion 275 define a first angle, α1, therebetween. The second pixel electrode 260 has a plurality of second pixel electrode stripes, for example, 261-265 and 261a-265a, a top portion 266 and a bottom portion 266a. The top portion 266 and the bottom portion 266a may be spaced-apart formed being parallel to each other, and aligned parallel to the ridge portion 275 of the first pixel electrode 270. The second pixel electrode stripes 261, 262, 263, 264, or 265 are spaced-apart extended from the top portion 266 towards the ridge portion 275 of the first pixel electrode 270, while the second pixel electrode stripe 261a, 262a, 263a, 264a, or 265a are spaced-apart extended from the bottom portion 266s towards the ridge portion 275 of the first pixel electrode 270. As such, each second pixel electrode stripe and the ridge portion 275 of the first pixel electrode 270 define a second angle, α2, therebetween, and the top and bottom portions 266 and 266a and the plurality of second pixel electrode stripes 261-265 and 261a-265a are formed symmetrically to the ridge portion 275 of the first pixel electrode 270. In this embodiment as shown in FIG. 2, the second angle α2 is same as the first angle α1.

According to the present invention, the second pixel electrode stripes 261-265 and 261a-265a and the plurality of first pixel electrode stripes 271-274 and 271a-274a are alternately positioned, defining eight pitches P₁, P₂, P₃, P₄, P₅, P₆, P₇ and P₈. Each of the pitches P₃, P₄, P₅, and P₆ has a width larger than that of the pitches P₁, P₂, P₇ and P₈, respectively. Specifically, the width of at least one of the pitches is different from the width of the other pitches. In this way, the gray level gamma curve of the LCD device can be optimized due to the different pitch widths between the first pixel electrode and second pixel electrode stripes. Further, as shown in FIG. 2, the plurality of second pixel electrode stripes 261-265 and 261a-265a and the plurality of first pixel electrode stripes 271-274 and 271a-274a are parallel-positioned so that, although the pitch widths may be different, each pitch has a uniform width along the adjacent common and first pixel electrode stripes. In this exemplary embodiment, each second pixel electrode stripe and each first pixel electrode stripe are a straight stripe.

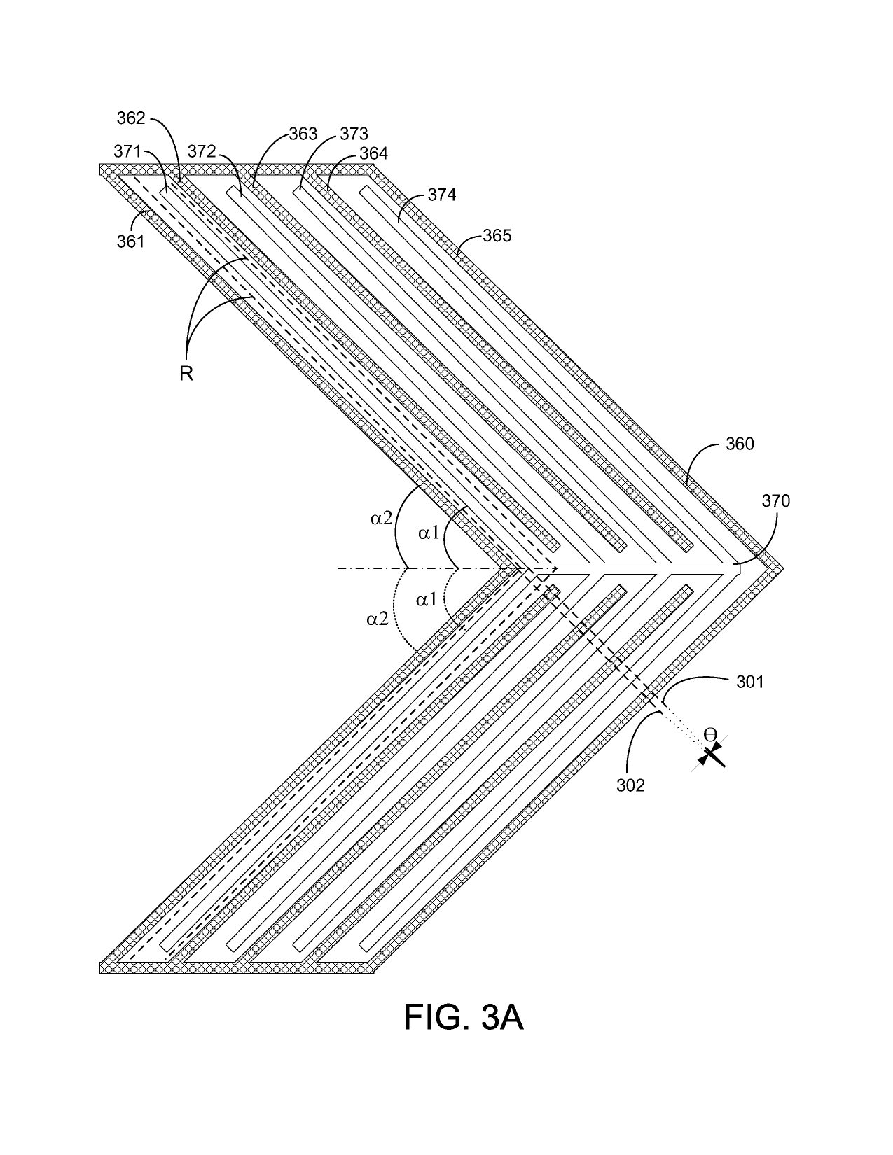

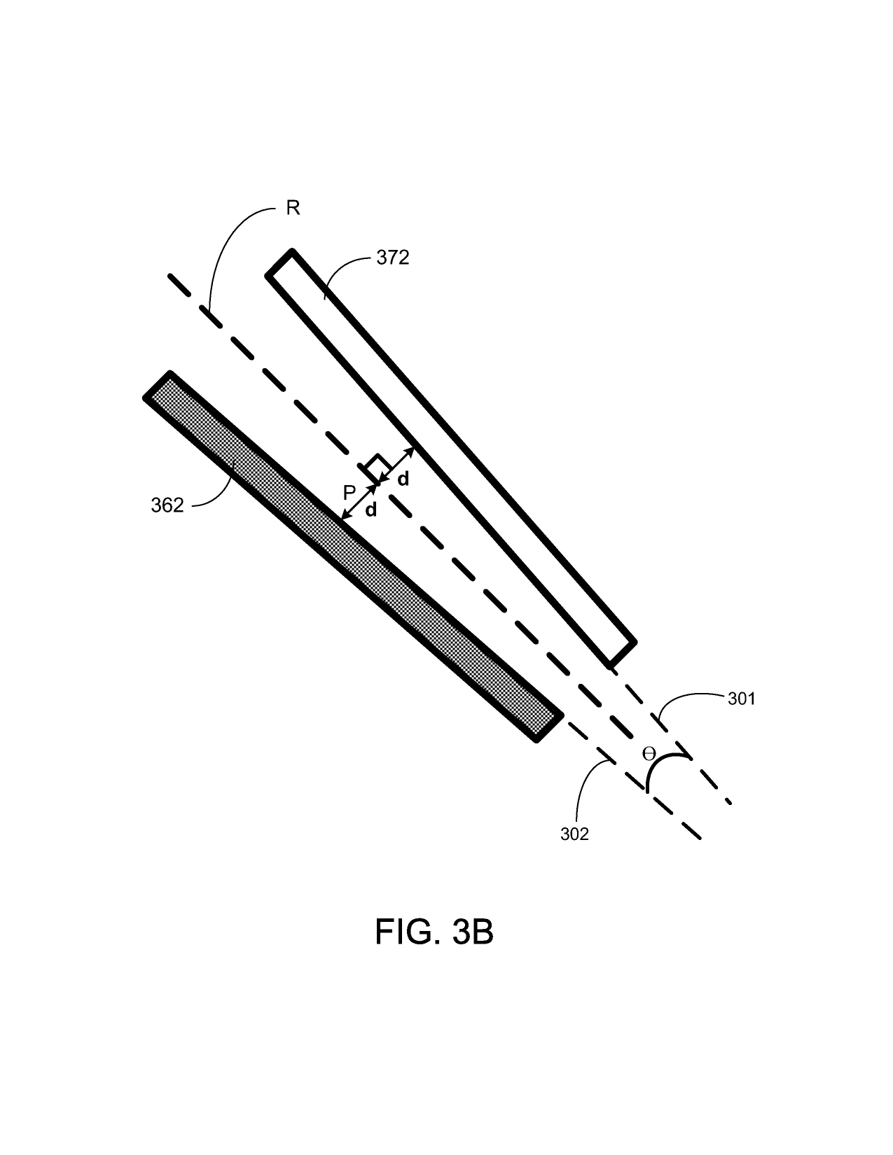

According to the present embodiment, the width of each pitch can be variable along the two adjacent first pixel electrode and second pixel electrode stripes. For example, the width of each pitch can be variable because the second pixel electrode stripes and the first pixel electrode stripes extend along different directions. In other words, the angles α1 and α2 are different from each other. As shown in FIG. 3A, the second pixel electrode 360 has a plurality of second pixel electrode stripes, for example, 361, 362, 363, 364 and 365, and the first pixel electrode 370 has a plurality of first pixel electrode stripes, for example, 371, 372, 373 and 374 (only top portions of first pixel electrode and second pixel electrode stripes are numerically indicated in FIGS. 3A and 3B). Each second pixel electrode stripe and each first pixel electrode stripe are a straight stripe. Although the second pixel electrode stripes 361, 362, 363, 364 and 365 are equally distant and the first pixel electrode stripes 371, 372, 373 and 374 are equally distant, each of the first pixel electrode stripes extends along a first direction 301, and each of the second pixel electrode stripes extends along a second direction 302 different from the first direction 301, forming a sharp angle θ between the first and second directions 301 and 302. Thus, each of the eight pitches defined by the adjacent first pixel electrode and second pixel electrode stripes would have a variable width along the adjacent first pixel electrode and second pixel electrode stripes. Accordingly, in each cross-section of the electrode structure, the pitch width ratio between each pitch would be different, and the gray level gamma curve of the LCD device can be optimized due to the different pitch widths in different cross-sections along the electrode stripes.

It should be appreciated to those of skill in the art that, when the first pixel electrode stripes and the second pixel electrode stripes extend along different directions, as shown in FIGS. 3A and 3B, the width of a pitch P is defined as a distance of the perpendicular line to the reference line R between the adjacent second pixel electrode stripe 362 and the first pixel electrode stripe 372. In this case, the reference line R is a straight line. In this case, the distance between the adjacent second pixel electrode stripe 362 or the first pixel electrode stripe 372 with respect to the reference line R would be d, where the width of the pitch P would be P=2*d. As shown in FIG. 3B, the reference line R is located between the adjacent second pixel electrode stripe 362 and the first pixel electrode stripe 372 so that the adjacent second pixel electrode stripe 362 and the first pixel electrode stripe 372 are symmetric with respect to the reference line R. As shown in FIGS. 3A and 3B, the reference lines R are sequentially arranged, of identical lengths, and/or parallel with each other, for example.

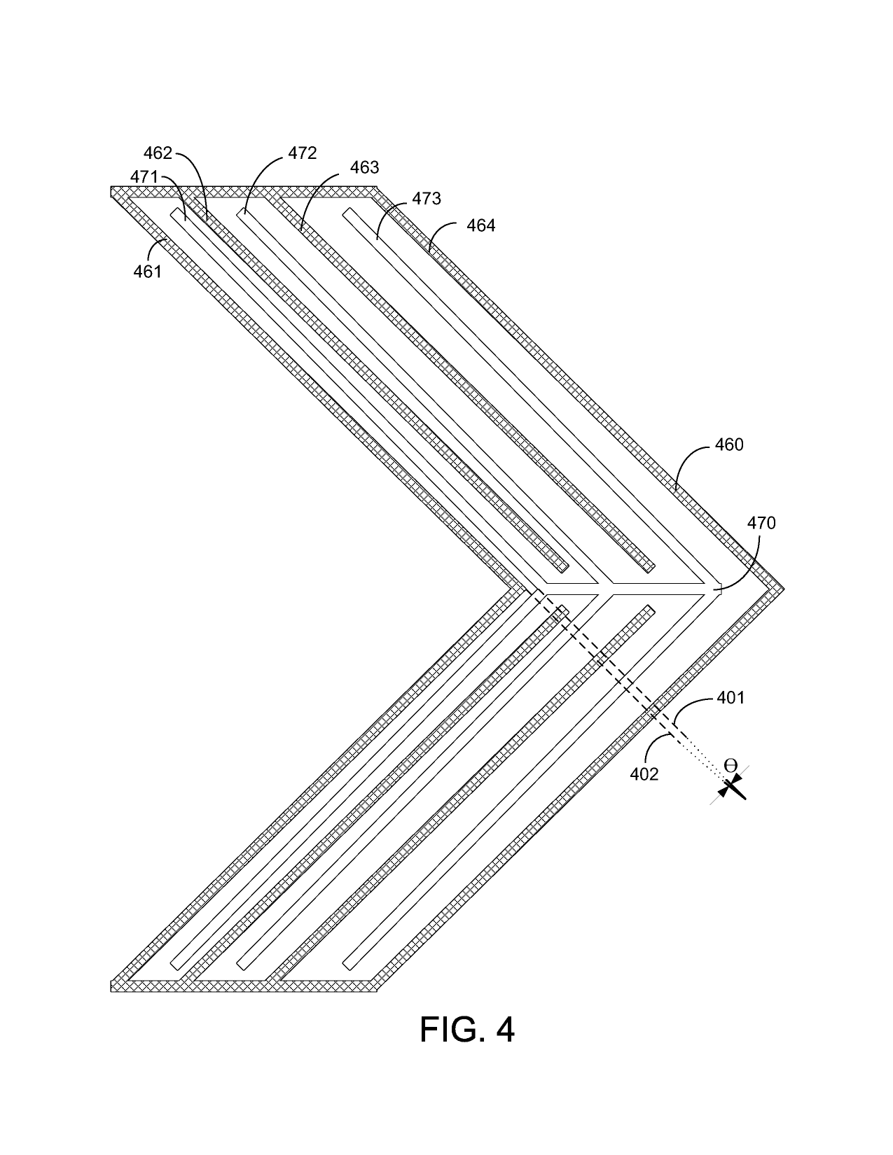

FIG. 4 shows schematically another embodiment of the electrode structure of the LCD device. As shown in FIG. 4, the second pixel electrode 460 has a plurality of second pixel electrode stripes 461, 462, 463 and 464, and the first pixel electrode 470 has a plurality of first pixel electrode stripes 471, 472 and 473. The second pixel electrode stripes 461, 462, 463 and 464 are unequally distant, and the first pixel electrode stripes 471, 472 and 473 are also unequally distant. Further, each of the first pixel electrode stripes extends along a first direction 401, and each of the second pixel electrode stripes extends along a second direction 402 different from the first direction 401, forming a sharp angle θ between the first and second directions 410 and 402. Although the electrode structure as shown in FIG. 4 has only six pitches, the width of each pitch would be different from each other and would be continuously variable along the adjacent electrode stripes. Accordingly, the gray level gamma curve of the LCD device can be optimized due to the multi-variable pitch widths along the adjacent electrode stripes and the different pitch widths between the electrode stripes.

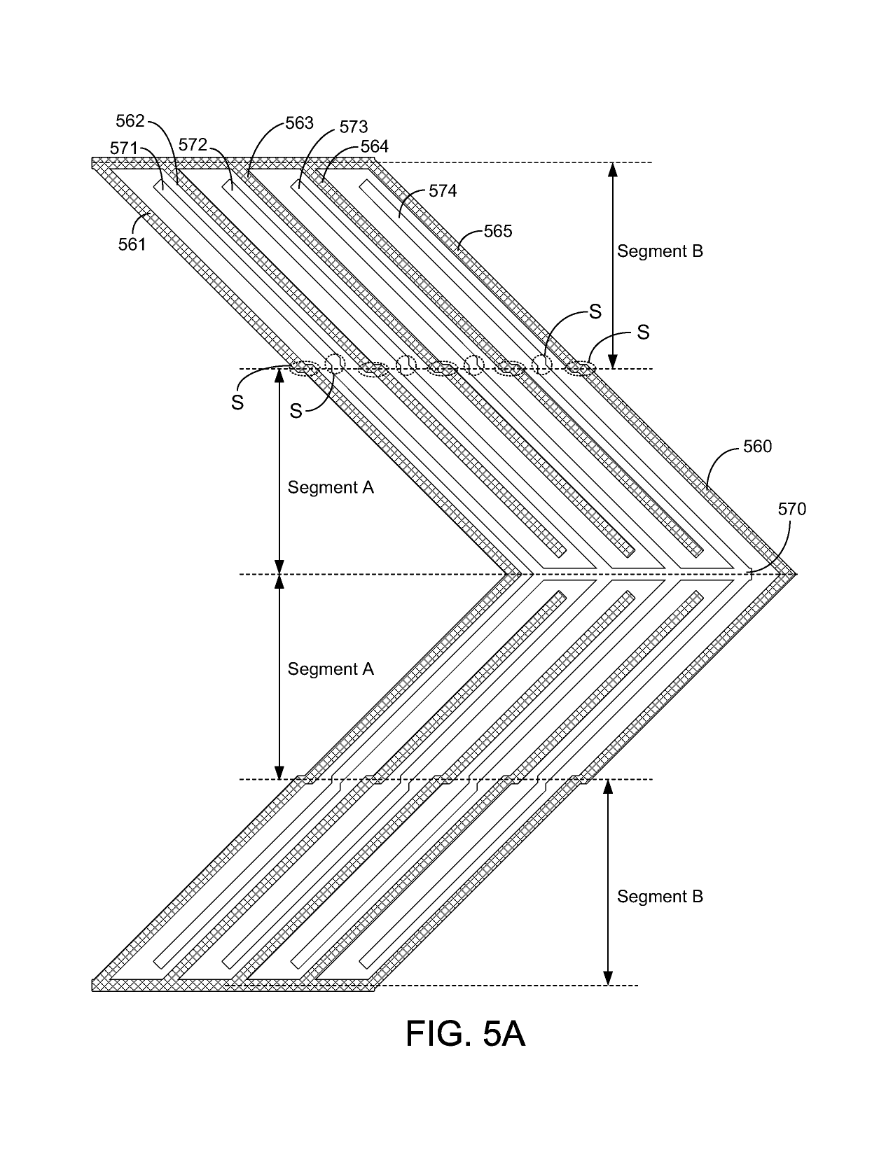

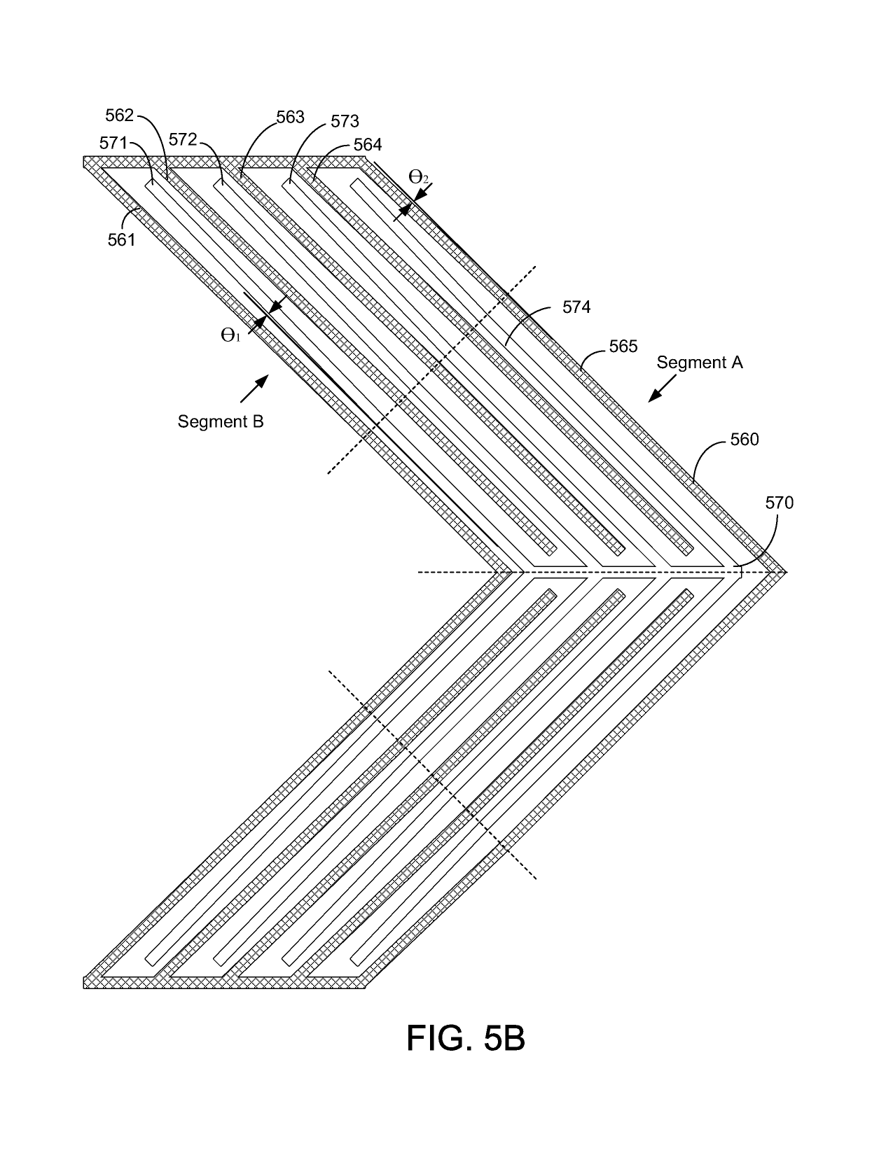

In another embodiment, the width of each pitch can be variable along the adjacent first pixel electrode and second pixel electrode stripes by separating the electrode stripes into different segments. For example, the width of each pitch can be variable because all the second pixel electrode stripes and the first pixel electrode stripes are separated into two segments. As shown in FIG. 5A, the second pixel electrode 560 has a plurality of second pixel electrode stripes 561, 562, 563, 564 and 565, and the first pixel electrode 570 has a plurality of first pixel electrode stripes 571, 572, 573 and 574. Further, the second pixel electrode stripes 561, 562, 563, 564 and 565 and the first pixel electrode stripes 571, 572, 573 and 574 are divided into first and second portions in segment A and segment B, respectively, i.e., each second pixel electrode stripe and each first pixel electrode stripe are a step-like stripe. In each of the segments A and B, the second pixel electrode stripes 561, 562, 563, 564 and 565 and the first pixel electrode stripes 571, 572, 573 and 574 extend along the same direction, but the width of each pitch between the adjacent first pixel electrode and second pixel electrode stripes in the segment A is different from the width in segment B due to the discrete formation of the adjacent first pixel electrode and second pixel electrode stripes. Thus, each of the eight pitches defined by the adjacent first pixel electrode and second pixel electrode stripes would have a variable width in the two segments along the adjacent first pixel electrode and second pixel electrode stripes, i.e., the width of each pitch varies discontinuously along the adjacent first pixel electrode and second pixel electrode stripes. For each of the first pixel electrode stripes 571, 572, 573 and 574, the first and second portions of the first pixel electrode stripe in the segments A and B are connected by the slant portion S so that the first pixel electrode stripe is a step-like stripe. For each of the second pixel electrode stripes 561, 562, 563, 564 and 565, the first and second portions of the second pixel electrode stripe in the segments A and B are connected by the slant portion S so that the second pixel electrode stripe is a step-like stripe. Accordingly, in each cross-section of the electrode structure, the pitch width ratio between each pitch would be different in different segments, and the gray level gamma curve of the LCD device can be optimized due to the different pitch widths in different segments along the electrode stripes.

In an alternative embodiment as shown in FIG. 5B, the second pixel electrode 560 has a plurality of second pixel electrode stripes 561, 562, 563, 564 and 565, and the first pixel electrode 570 has a plurality of first pixel electrode stripes 571, 572, 573 and 574. Further, the second pixel electrode stripes 561, 562, 563, 564 and 565 and the first pixel electrode stripes 571, 572, 573 and 574 are divided into segment A and segment B. In the segment A, the second pixel electrode stripes 561, 562, 563, 564 and 565 and the first pixel electrode stripes 571, 572, 573 and 574 extend along a first direction. However, in the segment B, the first pixel electrode stripes 571, 572, 573 and 574 extend along a second direction, and the second pixel electrode stripes 561, 562, 563, 564 and 565 extend along a third direction, forming a sharp angle θ₁ between the first and second directions, and a sharp angle θ₂ between the first and third directions. Thus, each of the eight pitches defined by the adjacent first pixel electrode and second pixel electrode stripes would have a uniform width in the segment A and a variable width in the segment B along the adjacent first pixel electrode and second pixel electrode stripes. Accordingly, in the different cross-sections of the electrode structure, the pitch width ratio between each pitch would be uniform in segment A but different in segment B, and the gray level gamma curve of the LCD device can be optimized due to the different pitch width ratios in different segments along the electrode stripes.

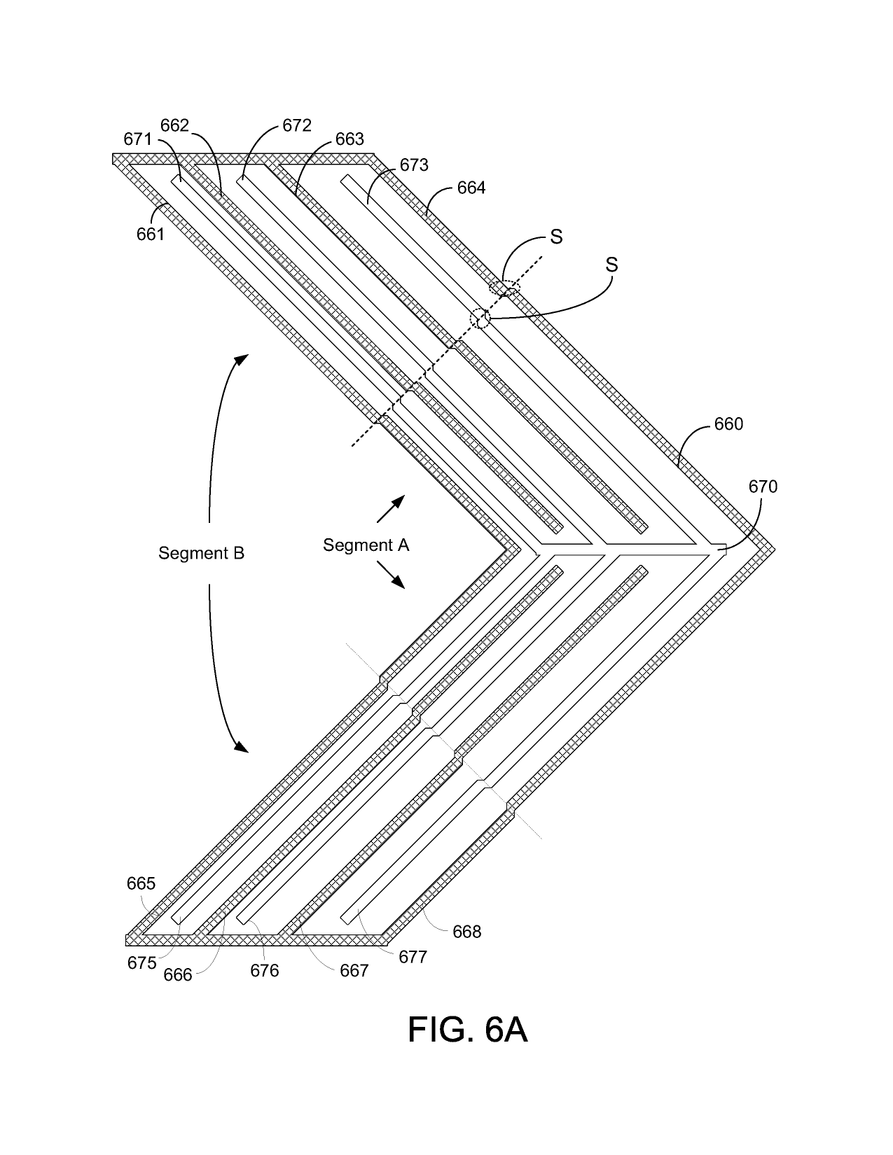

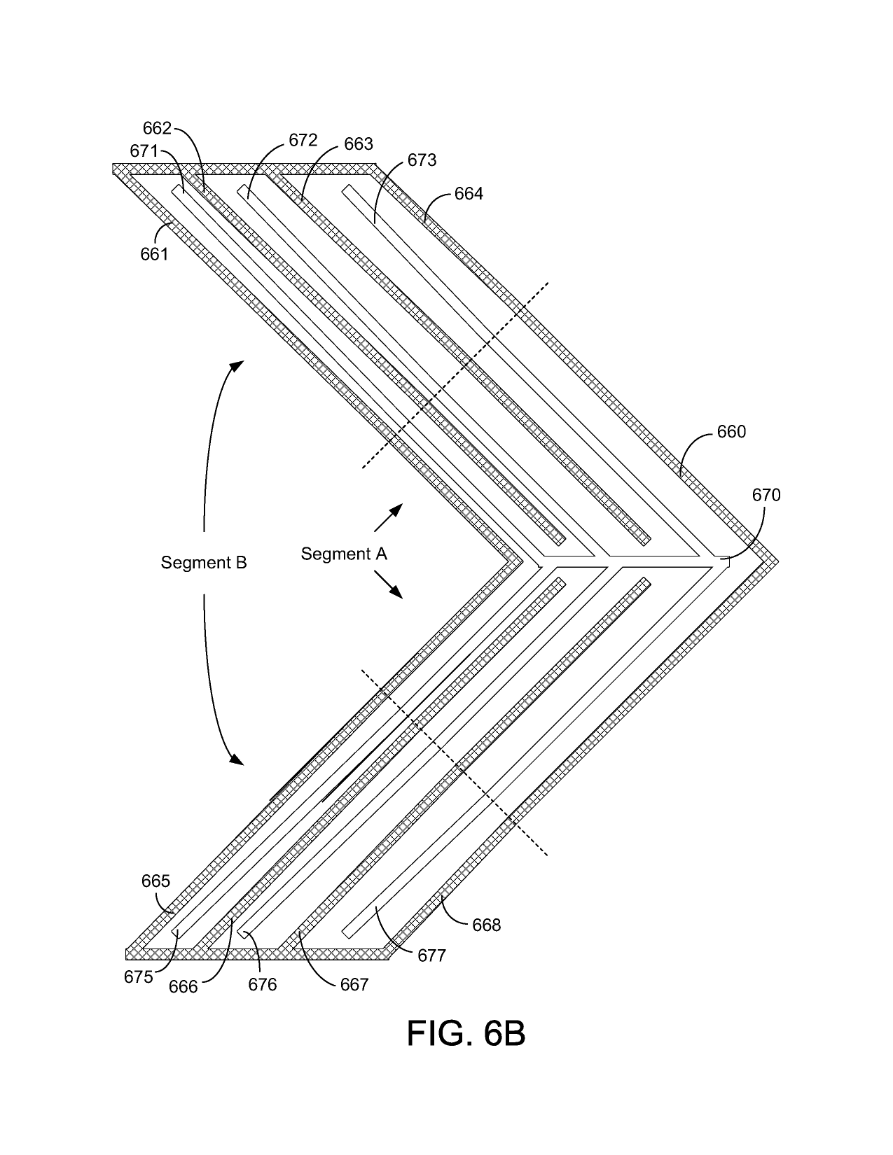

It should be appreciated to those of skill in the art that, although the electrode structures shown in FIGS. 2-5B have symmetrical electrode stripe structures, the electrode stripes can be staggered so that the variety of pitch widths can be increased. For example, FIGS. 6A and 6B show schematically two other embodiments of the staggered electrode structures of the LCD devices.

As shown in FIG. 6A, the second pixel electrode 660 has a plurality of second pixel electrode stripes 661, 662, 663 and 664 on the upper side of the figure and a plurality of second pixel electrode stripes 665, 666, 667 and 668 on the lower side of the figure, and the first pixel electrode 670 has a plurality of first pixel electrode stripes 671, 672 and 673 on the upper side of the figure and a plurality of first pixel electrode stripes 675, 676 and 677 on the lower side of the figure. All the second pixel electrode stripes and the first pixel electrode stripes are unequally distant, and the first pixel electrode stripes 671, 672 and 673 on the upper side are positioned in a staggered way to the first pixel electrode stripes 675, 676 and 677 on the lower side. Further, all the first pixel electrode stripes and the second pixel electrode stripes are divided into segment A and segment B. In each of the segments A and B, the first pixel electrode stripes and the second pixel electrode stripes extend along the same direction, but the width of each pitch between the adjacent first pixel electrode and second pixel electrode stripes in the segment A is different from the width in segment B due to the discrete formation of the adjacent first pixel electrode and second pixel electrode stripes. Although the electrode structure as shown in FIG. 6A has only twelve pitches (six pitches on each side of the figure), each of the pitches defined by the adjacent first pixel electrode and second pixel electrode stripes would have a variable width in the two segments along the adjacent first pixel electrode and second pixel electrode stripes, and the width of each pitch would be different from each other. Accordingly, the gray level gamma curve of the LCD device can be optimized due to the multi-variable pitch widths along the adjacent electrode stripes and the different pitch widths between the electrode stripes.

Similarly, as shown in FIG. 6B, the second pixel electrode 660 has a plurality of second pixel electrode stripes 661, 662, 663 and 664 on the upper side of the figure and a plurality of second pixel electrode stripes 665, 666, 667 and 668 on the lower side of the figure, and the first pixel electrode 670 has a plurality of first pixel electrode stripes 671, 672 and 673 on the upper side of the figure and a plurality of first pixel electrode stripes 675, 676 and 677 on the lower side of the figure. All the second pixel electrode stripes and the first pixel electrode stripes are unequally distant, and the first pixel electrode stripes 671, 672 and 673 on the upper side are positioned in a staggered way to the first pixel electrode stripes 675, 676 and 677 on the lower side. Further, all the second pixel electrode stripes and the first pixel electrode stripes are divided into segment A and segment B. In the segment A, the first pixel electrode stripes and the second pixel electrode stripes on the same side of the figure extend along the same direction. However, in the segment B, the first pixel electrode and second pixel electrode stripes extend along different directions from the electrode stripes in the segment A. Although the electrode structure as shown in FIG. 6B has only twelve pitches (six pitches on each side of the figure), each of the pitches defined by the adjacent first pixel electrode and second pixel electrode stripes would have a uniform width in the segment A and a variable width in the segment B along the adjacent first pixel electrode and second pixel electrode stripes, and the width of each pitch would be different from each other. Accordingly, the gray level gamma curve of the LCD device can be optimized due to the multi-variable pitch widths along the adjacent electrode stripes and the different pitch widths between the electrode stripes.

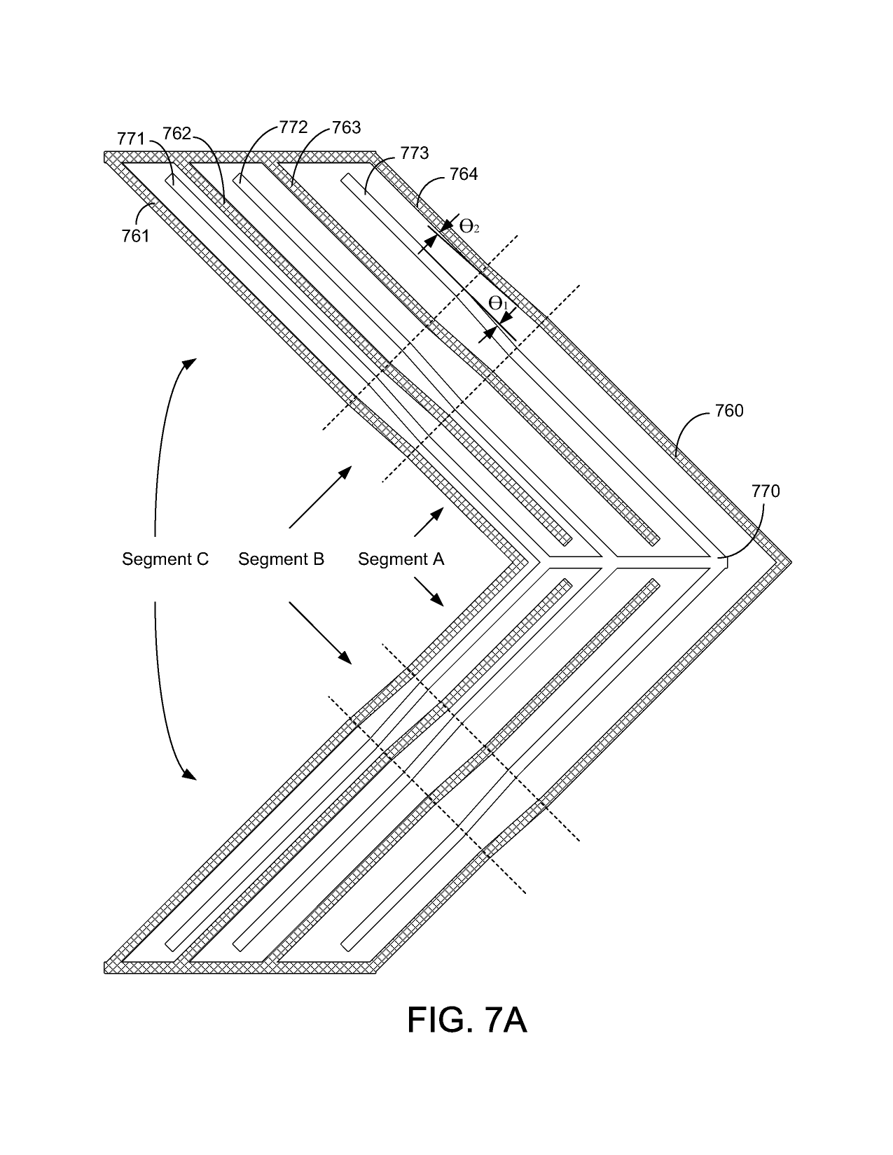

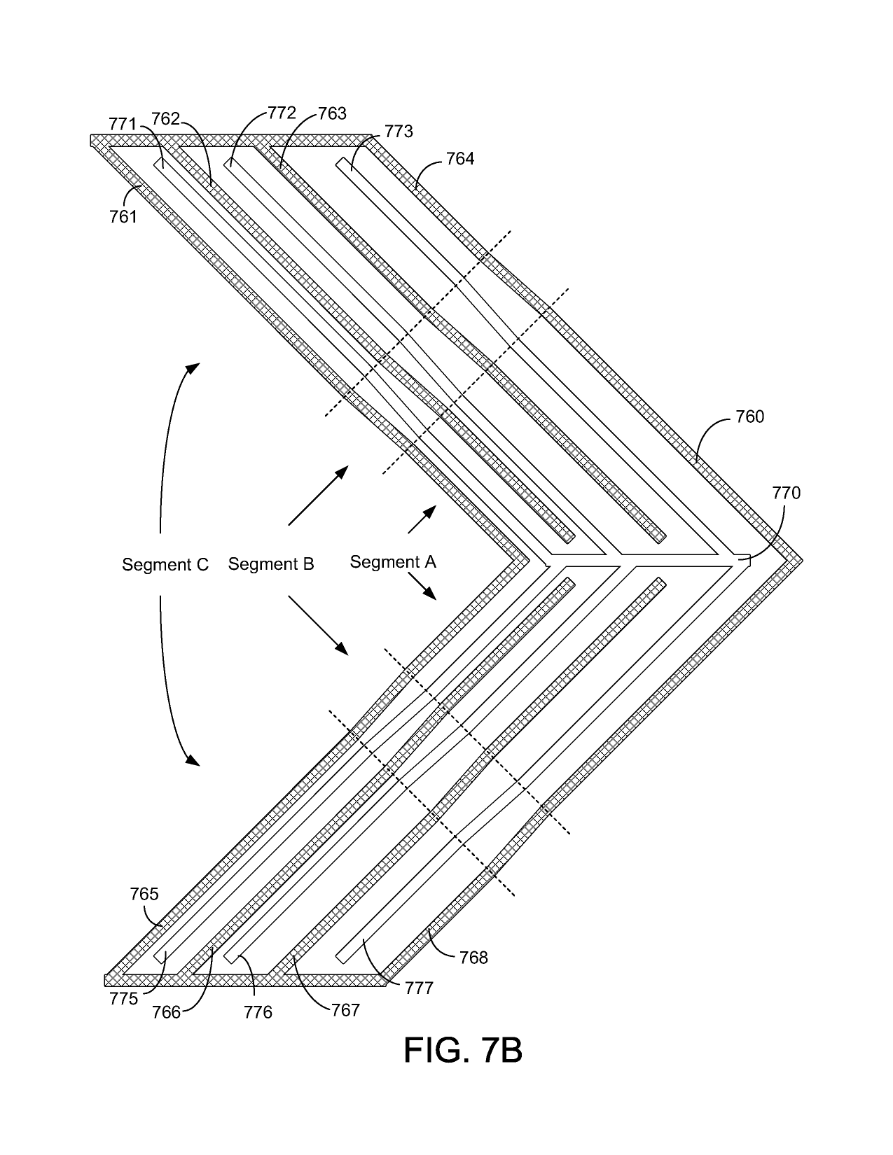

The embodiments disclosed in FIGS. 2-6B can be realized in any combination thereof. For example, FIGS. 7A and 7B shows two embodiments of the first pixel electrode structures where all the second pixel electrode stripes and the first pixel electrode stripes are unequally distant, and all the second pixel electrode stripes and the first pixel electrode stripes are separated into three segments A, B and C.

As shown in FIG. 7A, in the segments A and C, the second pixel electrode stripes 761, 762, 763 and 764 and the first pixel electrode stripes 771, 772 and 773 extend along the same direction. However, in the segment B, the first pixel electrode stripes 771, 772 and 773 and the second pixel electrode stripes 761, 762, 763 and 764 extend along different directions from the electrode stripes in the segments A and C. The electrode structure shown in FIG. 7B is essentially a similar structure to the structure shown in FIG. 7A, with the difference existing in that the first pixel electrode stripes 771, 772 and 773 on the upper side are positioned in a staggered way to the first pixel electrode stripes 775, 776 and 777 on the lower side. In this embodiment, each second pixel electrode stripe and each first pixel electrode stripe are a curved stripe or a slant stripe. Although the electrode structure as shown in FIGS. 7A and 7B has only twelve pitches (six pitches on each side of the figure), each of the pitches defined by the adjacent first pixel electrode and second pixel electrode stripes would have a variable width in the three segments along the adjacent first pixel electrode and second pixel electrode stripes, and the width of each pitch would be different from each other. Accordingly, the gray level gamma curve of the LCD device can be optimized due to the multi-variable pitch widths along the adjacent electrode stripes and the different pitch widths between the electrode stripes.

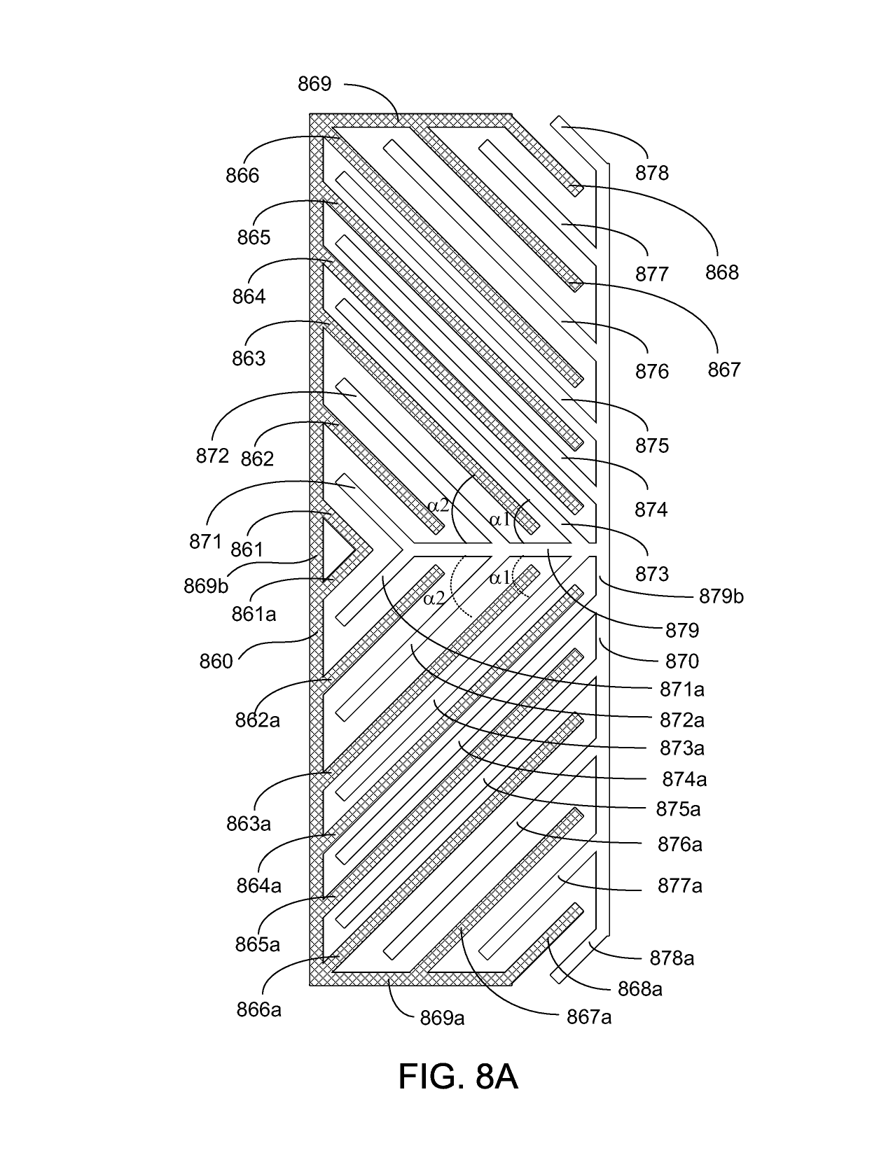

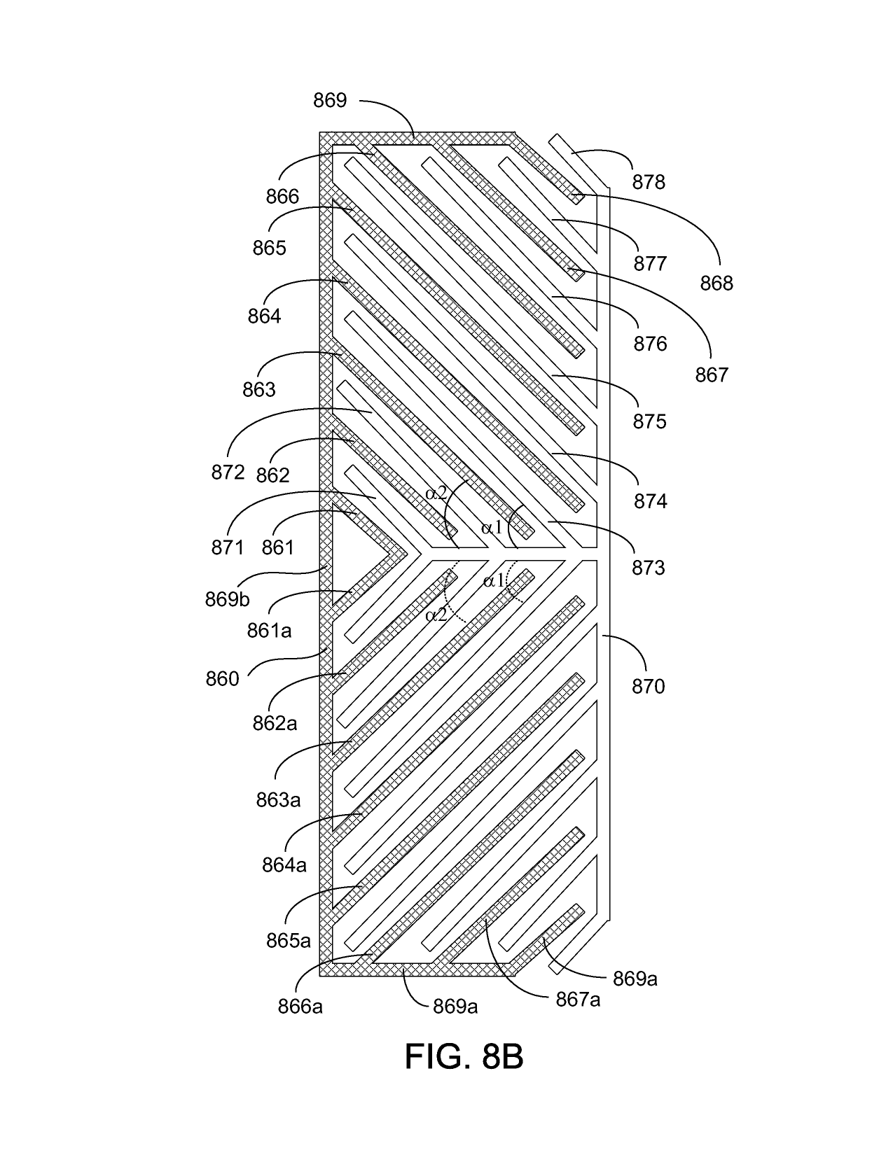

It should be appreciated to those of skill in the art that, although the embodiments shown in FIGS. 2-7B have vertical-type electrode structures, the present invention can be applied to any type of electrode structures. For example, FIGS. 8A and 8B show two embodiments of the first pixel electrode structures where the second pixel electrode 860 and the first pixel electrode 870 are disposed in horizontal electrode structures. As shown in FIGS. 8A and 8B, the second pixel electrode 860 has a plurality of second pixel electrode stripes, for example, 861-868 and 861a-868a, and the first pixel electrode 870 has a plurality of first pixel electrode stripes, for example, 871-878 and 871a-878a. The plurality of first pixel electrode stripes 871-878 and 871a-878a and the plurality of second pixel electrode stripes 861-868 and 861a-868a are alternately placed to define a plurality of pitches therebetween, where each pitch is defined by two adjacent first pixel electrode and second pixel electrode stripes. The first pixel electrode 870 also has a side portion 879b and a ridge portion 879 perpendicularly extended from the side portion 879b. Further, each first pixel electrode stripe is extended from one of the side portion 879b and the ridge portion 879 such that each first pixel electrode stripe and the ridge portion 879 define a first angle, α1, therebetween. In the exemplary embodiment, the side portion 879b and the plurality of first pixel electrode stripes 871-878 and 871a-878a are formed symmetrically to the ridge portion 879. In addition, the second pixel electrode 860 further has a side portion 869b having a first end and an opposite, second end, a top portion 869 and a bottom portion 869a perpendicularly extended from the first and second ends, respectively, of the side portion 869b that is aligned parallel to the side portion 879b of the first pixel electrode 870. In the example, each second pixel electrode stripe is extended from one of the top and bottom portions 869 and 869a towards the ridge portion 879 of the first pixel electrode 870 such that each second pixel electrode stripe and the ridge portion 879 of the first pixel electrode 870 define a second angle, α2, therebetween. For this example, the top, bottom and side, portions 869, 869a and 869b and the plurality of second pixel electrode stripes 861-868 and 861a-868a are placed symmetrically to the ridge portion 879 of the first pixel electrode 870. The electrode structure shown in FIG. 8A is similar to the electrode structure shown in FIG. 2, where all the second pixel electrode stripes 861-868 and 861a-868a and the first pixel electrode stripes 871-878 and 871a-878a are parallel-positioned and the widths of the pitches are different. In this exemplary embodiment, the first and second angles α1 and α2 are the same. The electrode structure shown in FIG. 8B is similar to the electrode structure shown in FIG. 3A, where the second pixel electrode stripes 861-868 and 861a-868a extend along one direction, and the first pixel electrode stripes 871-878 and 871a-878a extend along a different direction, i.e., the first and second angles α1 and α2 are substantially different, thereby defining a plurality of pitches having variable widths along the adjacent second pixel electrode stripe and first pixel electrode stripe.

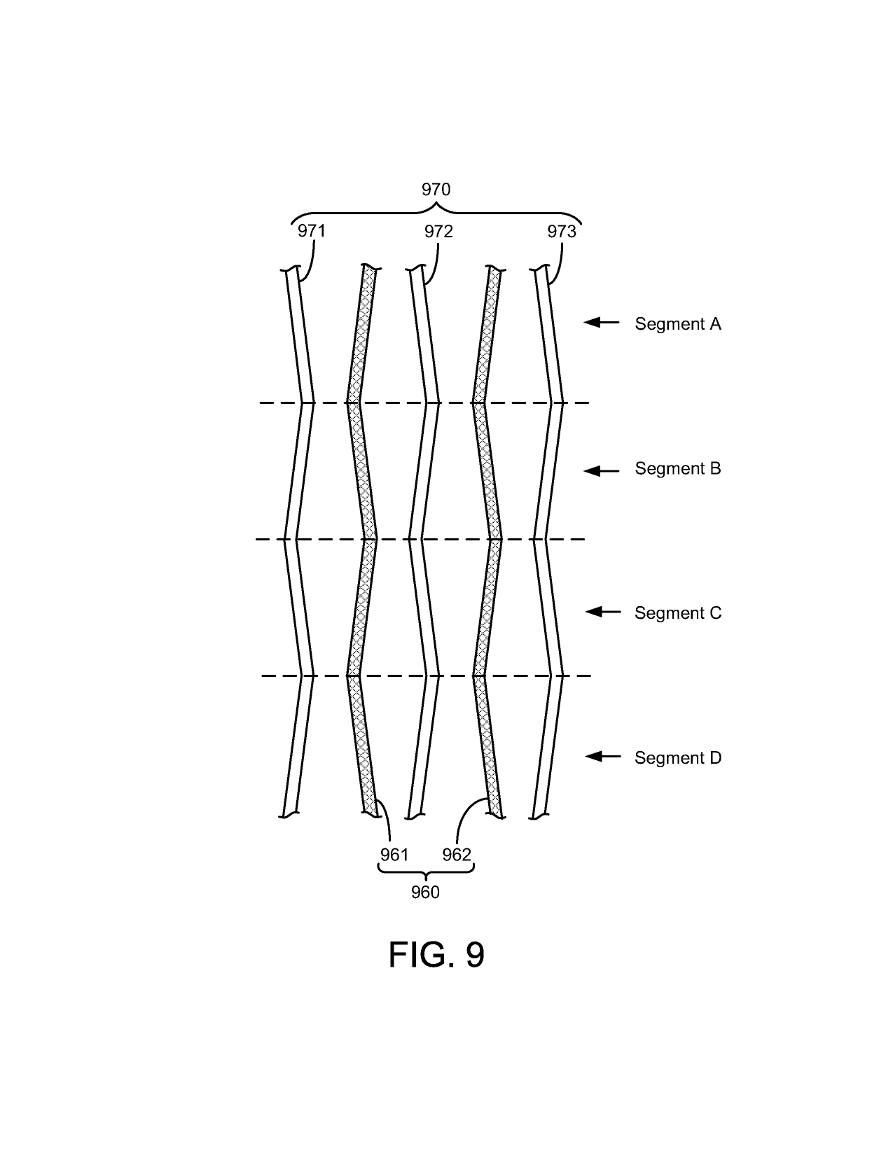

In another embodiment, the first pixel electrode stripes and the second pixel electrode stripes may be divided into a plurality of segments. In each segment, the width of each pitch varies differently along the two adjacent first pixel electrode stripe and second pixel electrode stripe. As shown in FIG. 9, the first pixel electrode 970 has a plurality of first pixel electrode stripes 971, 972 and 973, and the second pixel electrode 960 has a plurality of second pixel electrode stripes 961 and 962. In this embodiment, the adjacent first pixel electrode stripes and second pixel electrode stripes are formed in mirrored or symmetric structures relative to the reference lines therebetween. Further, the first pixel electrode stripes 971, 972 and 973 and the second pixel electrode stripes 961 and 962 are divided into a first portion, a second portion, a third portion and a fourth portion respectively in the segments A, B, C and D. In other words, each of the first and second pixel electrode stripes is a jagged stripe. Thus, each of the four pitches defined by the adjacent first pixel electrode and second pixel electrode stripes would have a different variable width in the segments A, B, C and D. For example, for the pitch defined between the first pixel electrode stripe 971 and the second pixel electrode stripe 961, the width of the pitch in segment A is gradually reduced from the top to the bottom of the figure, the width of the pitch in segment B is gradually increased from the top to the bottom of the figure, the width of the pitch in segment C is gradually reduced from the top to the bottom of the figure, and the width of the pitch in segment D is gradually increased from the top to the bottom of the figure. Accordingly, the gray level gamma curve of the LCD device can be optimized due to the different variable pitch widths in different segments along the reference lines between the electrode stripes.

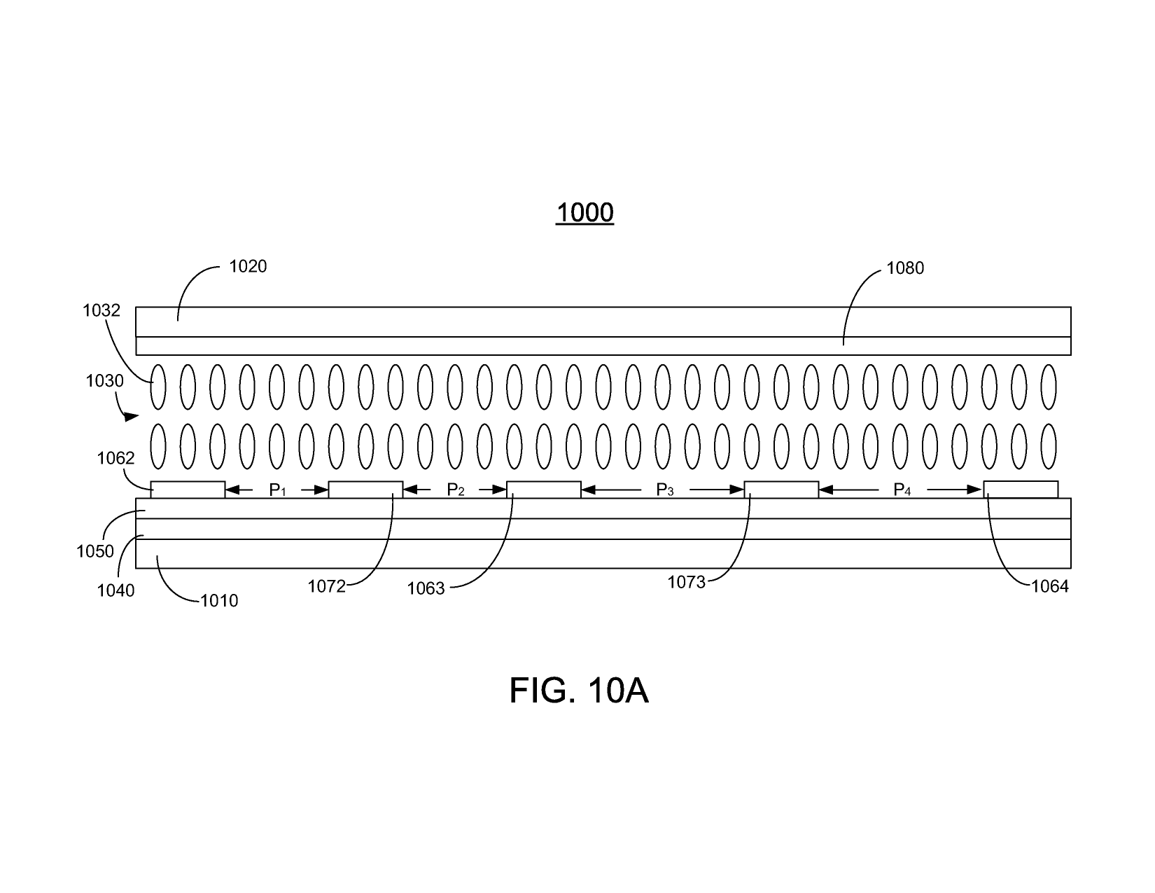

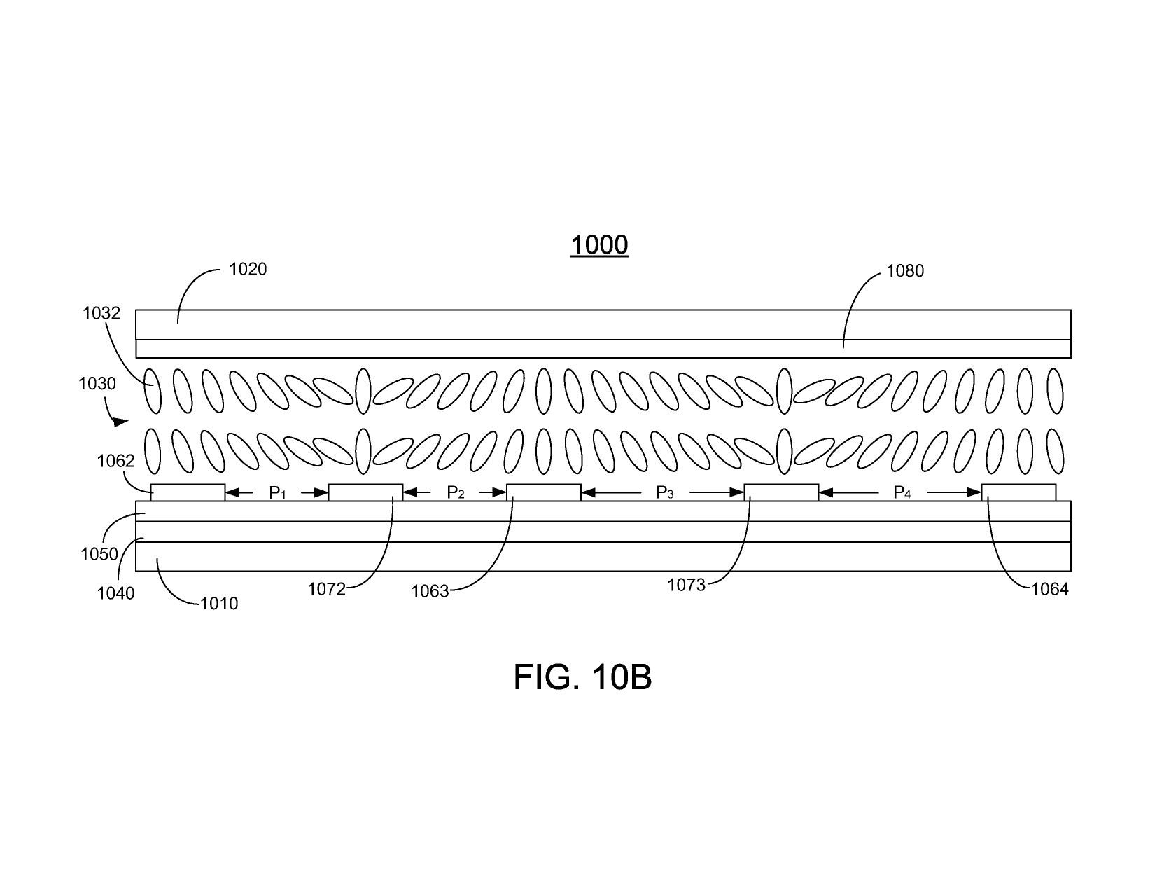

The embodiments of the first pixel electrode structures as shown in FIGS. 2-9 can be applied to the VA-IPS structure as shown in FIGS. 1A and 1B or the TBA structure. FIGS. 10A and 10B show schematically two partial cross-sectional views of an LCD device 1000 according to one embodiment of the present invention. FIG. 10A shows a liquid crystal orientation of the LCD device 1000 when no voltage is applied, while FIG. 10B shows the liquid crystal orientation of the LCD device 1000 when a voltage is applied. According to the embodiment, the LCD device 1000 utilizes the TBA technology, and includes similar elements to the LCD device 100 as shown in FIGS. 1A and 1B. The only difference exists that, in FIGS. 10A and 10B, each pixel may further include a counter electrode 1080 formed on the second substrate 1020. In one embodiment, the counter electrode 1080 is electrically connected to the second pixel electrode so that, when a voltage is applied, the counter electrode 1080 and the second pixel electrode stripes 1062, 1063 and 1064 would be applied the same voltage Vcom. In another embodiment of the present invention, the counter electrode 1080 is electrically connected to the second pixel electrode so that, when a voltage is applied, the counter electrode 1080 and the second pixel electrode stripes 1072 and 1073 would be applied the same voltage Vcom. In yet another embodiment, the counter electrode 1080 is applied with an AC voltage or a DC voltage. Other elements and features of the LCD device according to the embodiment shown in FIGS. 10A and 10B are essentially the same as the embodiment of the LCD device shown in FIGS. 1A and 1B.

In one embodiment, an AC voltage is applied to the first pixel electrode, while an AC or DC voltage is applied to the second pixel electrode. In another embodiment, an AC voltage is applied to the second pixel electrode, while an AC or DC voltage is applied to the first pixel electrode.

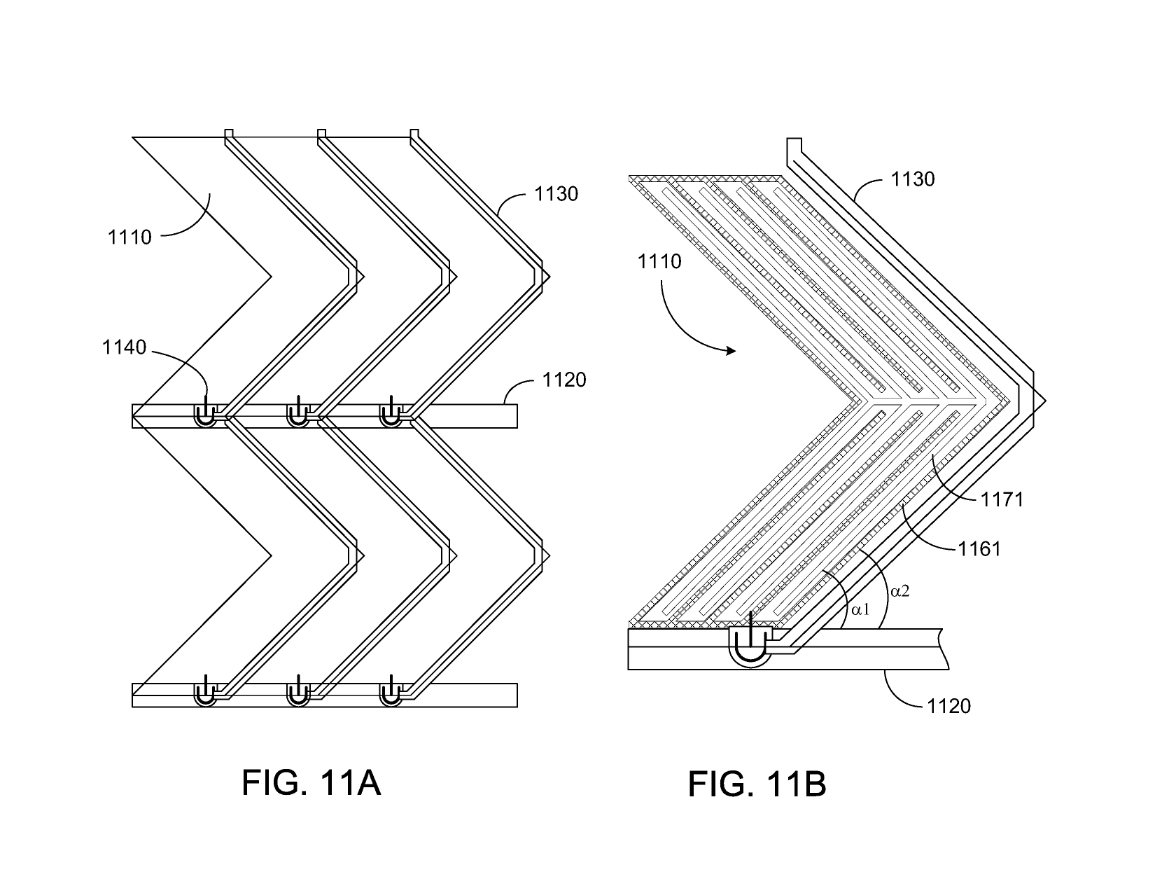

It should be appreciated to those of skill in the art that the aforementioned embodiments can be utilized in any form of the LCD devices or panels with different pixel arrangements. For example, FIG. 11A shows one embodiment of the pixel arrangements of an LCD device, where each pixel includes a vertical pixel structure 1110, as disclosed above, for example, in FIGS. 2-7B.

As shown in FIG. 11A, the pixel arrangement has a plurality of pixels 1110. A plurality of gate lines 1120 is electrically connected to the pixels 1110, and a plurality of signal lines 1130 is electrically connected to the pixels 1110 for controlling driving signals of each pixel. Further, each pixel 1110 has a thin-film transistor (TFT) 1140 serving as a driving/switch device for controlling the voltage provided to the first and second electrodes of the pixel 1110 through the corresponding gate line 1120 and the corresponding signal line 1130. FIG. 11B shows an exemplary pixel structure 1110 electrically connected to the gate line 1120 and the signal line 1130. In the example, each first pixel electrode stripe 1171 and one of the gate lines 1120 form a first angle, α1 in a segment, and each second pixel electrode stripe 1161 and the one of the gate lines 1120 form a second angle, α2 in the segment. The first and second angle α1 and α2 can be same or substantially different. In the example shown in FIG. 11B, α1=α2.

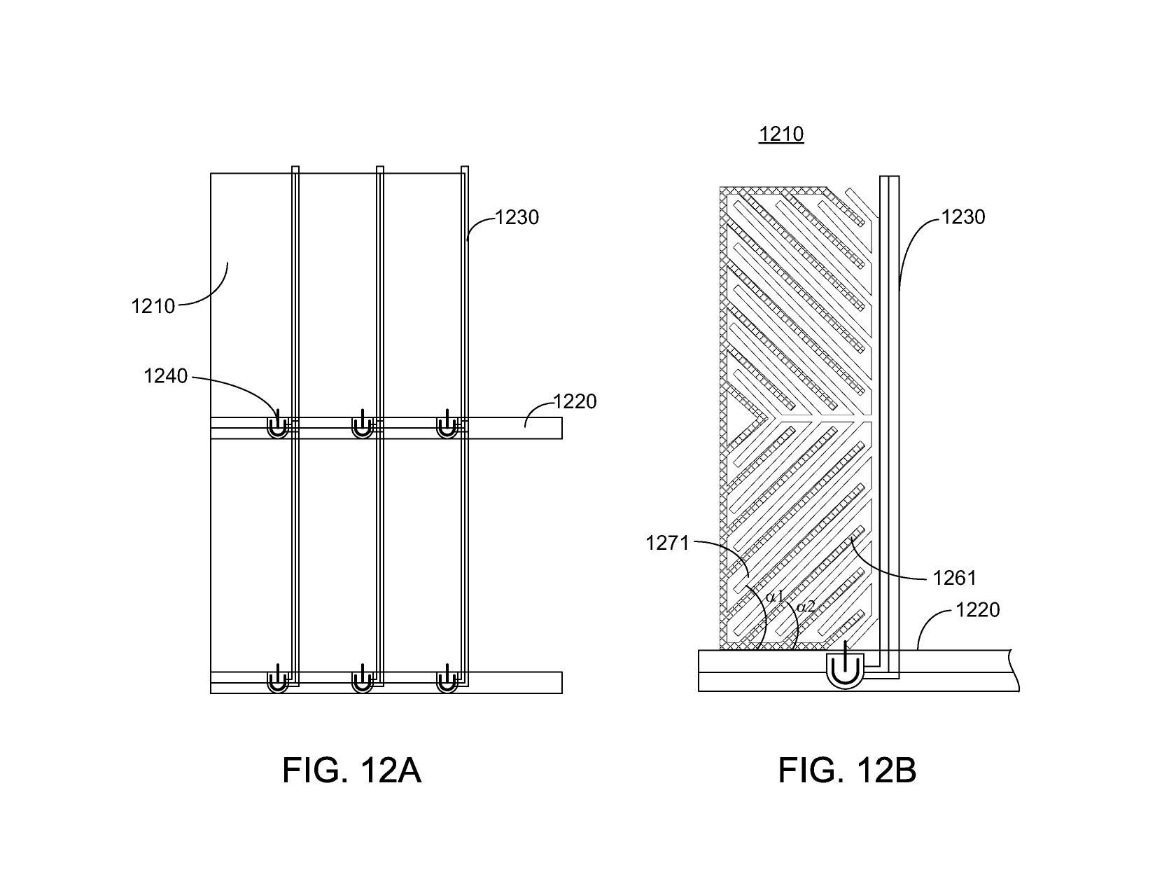

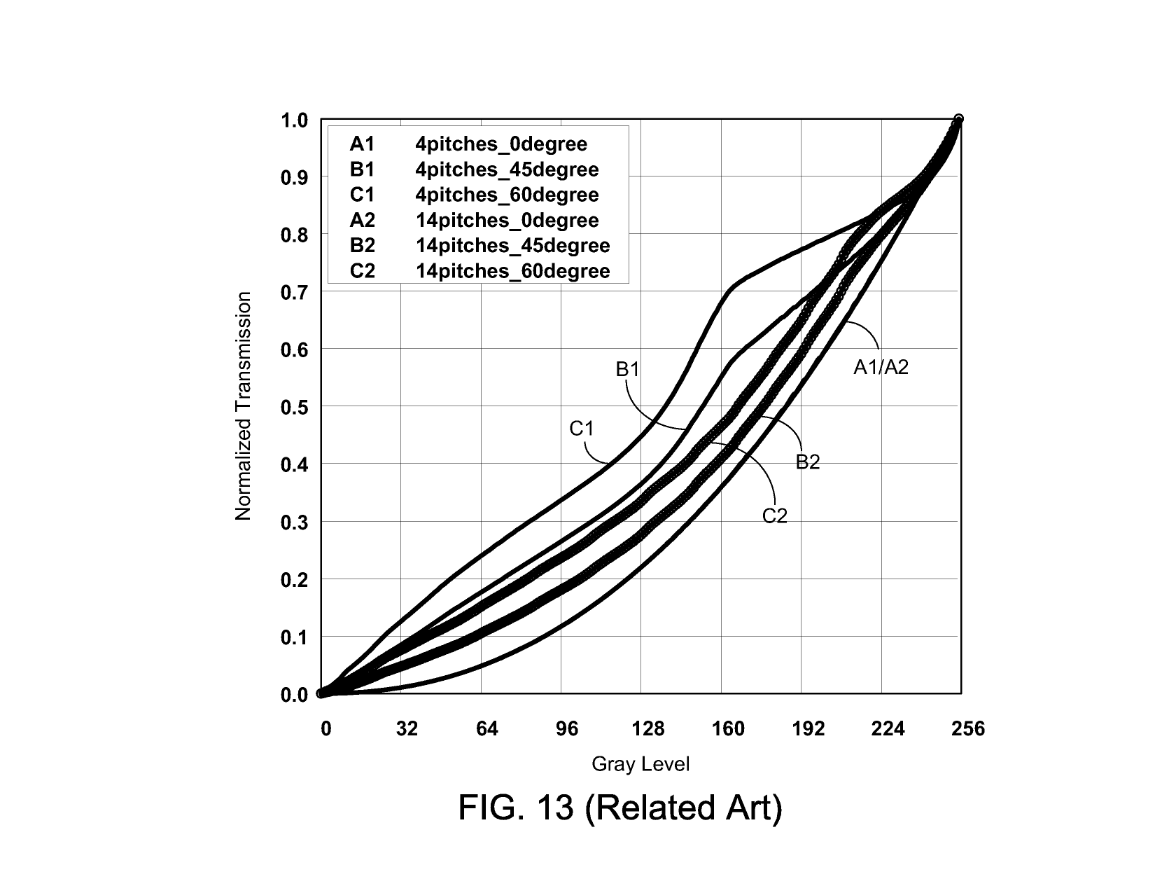

Any other pixel structures, if applicable to the LCD devices or panels, can also be applied with the electrode structures of the present invention. For example, referring to FIGS. 12A and 12B, a pixel arrangement of horizontal pixel structures in an LCD device is shown, where each pixel includes a horizontal pixel structure 1210, as disclosed above, for example, in FIGS. 8A and 8B. Similarly, a plurality of gate lines 1220 is electrically connected to the pixels 1210, and a plurality of signal lines 1230 is electrically connected to the pixels 1210 for controlling driving signals of each pixel 1210. Further, each pixel 1210 has a thin-film transistor (TFT) 1240 serving as a driving/switch device for controlling the voltage provided to the electrodes of the pixel 1210 through the gate line 1220 and the signal line 1230. FIG. 12B shows an exemplary pixel structure 1210 electrically connected to the corresponding gate line 1220 and the corresponding signal line 1230. In the example shown in FIG. 12B, each first pixel electrode stripe 1271 and one of the gate lines 1220 form a first angle, α1, and each second pixel electrode stripe 1261 and the one of the gate lines 1220 form a second angle, α2. The first and second angle α1 and α2 can be same or substantially different. In the example shown in FIG. 12B, α1#α2.

In sum, the invention, among other things, recites a LCD device including a pixel matrix having a plurality of pixels. Each pixel includes a first pixel electrode having a plurality of first pixel electrode stripes and a second pixel electrode having a plurality of second pixel electrode stripes. The first pixel electrode stripes and the second pixel electrode stripes are alternately placed to define a plurality of pitches therebetween. Each pitch is defined between two adjacent first pixel electrode and second pixel electrode stripes, and has a width. The width of at least one of the pitches is different from that of the other pitches. Additionally, the width of each pitch is variable along the adjacent first pixel electrode and second pixel electrode stripes. Accordingly, the gray level gamma curve of the LCD device can be optimized due to the multi-variable pitch widths along the adjacent electrode stripes and the different pitch widths between the electrode stripes.

In the embodiments shown above, each pixel may further include a counter electrode formed on the second substrate. The counter electrode is electrically connected to the second pixel electrode or the first electrode. Alternatively, the counter electrode is electrically connected to an AC voltage or a DC voltage.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A liquid crystal display device, comprising:
(a) a first substrate and a second substrate positioned apart to define a cell gap therebetween;
(b) a liquid crystal layer positioned in the cell gap between the first substrate and the second substrate, defining a plurality of liquid crystal cells; and
(c) a pixel matrix having a plurality of pixels formed on the first substrate, each pixel being associated with a corresponding liquid crystal cell and comprising:
a first pixel electrode having a plurality of first pixel electrode stripes; and
a second pixel electrode having a plurality of second pixel electrode stripes,
wherein the plurality of first pixel electrode stripes and the plurality of second pixel electrode stripes are alternately placed to define a plurality of pitches therebetween;
wherein each pitch is defined by two adjacent first pixel electrode stripe and second pixel electrode stripe, and has a width variable along the adjacent first pixel electrode stripe and second pixel electrode stripe; and
wherein a reference line is located between the two adjacent first pixel electrode stripe and second pixel electrode stripe so that the two adjacent first pixel electrode stripe and second pixel electrode stripe are symmetric with respect to the reference line.

2. The liquid crystal display device of claim 1, wherein the first pixel electrode of each of the pixels further has a ridge portion, and wherein each first pixel electrode stripe thereof is connected with the ridge portion such that each first pixel electrode stripe and the ridge portion form a first angle, α1

3. The liquid crystal display device of claim 2, wherein the second pixel electrode of each of the pixels further has a top portion and a bottom portion spaced-apart formed being parallel to the ridge portion of the first pixel electrode, wherein each second pixel electrode stripe is extended from one of the top and bottom portions towards the ridge portion of the first pixel electrode such that each second pixel electrode stripe and the ridge portion of the first pixel electrode form a second angle, α2, and wherein the second angle α2 is substantially different from the first angle α1.

4. The liquid crystal display device of claim 3, wherein the top and bottom portions and the plurality of second pixel electrode stripes of the second pixel electrode and the plurality of first pixel electrode stripes of the first pixel electrode are placed in the two sides of the ridge portion of the first pixel electrode.

5. The liquid crystal display device of claim 1, wherein the first pixel electrode further comprises a side portion and a ridge portion perpendicularly extended from the side portion, and wherein each first pixel electrode stripe is extended from one of the side portion and the ridge portion such that each first pixel electrode stripe and the ridge portion define a first angle, α1, therebetween.

6. The liquid crystal display device of claim 5, wherein the second pixel electrode further comprises a side portion having a first end and a opposite, second end, a top portion and a bottom portion perpendicularly extended from the first and second ends, respectively, of the side portion that is aligned parallel to the side portion of the first pixel electrode, wherein each second pixel electrode stripe is extended from one of the side, top and bottom portions towards the ridge portion of the first pixel electrode such that each second pixel electrode stripe and the ridge portion of the first pixel electrode define a second angle, α2, therebetween, and wherein the second angle α2 is substantially different from the first angle α1.

7. The liquid crystal display device of claim 6, wherein the side, top and bottom portions and the plurality of second pixel electrode stripes of the second pixel electrode, and the side portion and the plurality of first pixel electrode stripes of the first pixel electrode are placed symmetrically to the ridge portion of the first pixel electrode.

8. The liquid crystal display device of claim 1, wherein the width of each pitch varies continuously along the adjacent first pixel electrode and second pixel electrode stripes.

9. The liquid crystal display device of claim 1, wherein the width of each pitch varies discontinuously along the adjacent first pixel electrode and second pixel electrode stripes.

10. The liquid crystal display device of claim 1, wherein the width of at least one of the plurality of pitches is different from that of the other pitches.

11. The liquid crystal display device of claim 1, wherein each first pixel electrode stripe comprises a straight stripe, a curved stripe, a slant stripe, a jagged stripe or a step-like stripe, and wherein each second pixel electrode stripe comprises a straight stripe, a curved stripe, a slant stripe, a jagged stripe or a step-like stripe.

12. The liquid crystal display device of claim 1, wherein each pixel further comprises a counter electrode formed on the second substrate, and wherein the counter electrode is electrically connected to the first pixel electrode, the second pixel electrode, an AC voltage or a DC voltage.

13. The liquid crystal display device of claim 1, further comprising a plurality of gate lines and signal lines electrically connected to the pixels correspondingly, wherein each first pixel electrode stripe and one of the gate lines form a first angle, α1.

14. The liquid crystal display device of claim 13, wherein each second pixel electrode stripe and the one of the gate lines form a second angle, α2, and wherein the second angle α2 is substantially different from the first angle α1.

15. The liquid crystal display device of claim 1, wherein each of the first and second pixel electrode stripes is divided into a plurality of segments along the reference line, and the width of each pitch varies differently in each of the plurality of segments.

16. The liquid crystal display device of claim 15, wherein two adjacent first pixel electrode stripe and second pixel electrode stripe are symmetric.

17. A liquid crystal display, comprising:
(a) a first substrate and a second substrate positioned apart to define a cell gap therebetween;
(b) a liquid crystal layer positioned in the cell gap between the first substrate and the second substrate, defining a plurality of liquid crystal cells; and
(c) a pixel matrix having a plurality of pixels formed on the first substrate, each pixel being associated with a corresponding liquid crystal cell and comprising:
a first pixel electrode having a plurality of first pixel electrode stripes; and
a second pixel electrode having a plurality of second pixel electrode stripes,
wherein the plurality of first pixel electrode stripes and the plurality of second pixel electrode stripes are alternately placed to define a plurality of pitches therebetween; and
wherein each pitch is defined by two adjacent first pixel electrode and second pixel electrode stripes and has a width, wherein the width of at least one of the plurality of pitches is different from that of the other pitches, and wherein each of the first pixel electrode and second pixel electrode stripes is a step-like stripe.

18. The liquid crystal display device of claim 17, wherein the first pixel electrode further comprises a ridge portion, and wherein each first pixel electrode stripe is extended from the ridge portion such that each first pixel electrode stripe and the ridge portion define a first angle, α1, therebetween.

19. The liquid crystal display device of claim 18, wherein the second pixel electrode further comprises a top portion and a bottom portion spaced-apart formed being parallel to the ridge portion of the first pixel electrode, wherein each second pixel electrode stripe is extended from one of the top and bottom portions towards the ridge portion of the first pixel electrode such that each second pixel electrode stripe and the ridge portion of the first pixel electrode define a second angle, α2, therebetween, and wherein the second angle α2 is same as or substantially different from the first angle α1.

20. The liquid crystal display device of claim 19, wherein the top and bottom portions and the plurality of second pixel electrode stripes of the second pixel electrode and the plurality of first pixel electrode stripes of the first pixel electrode are placed in the two sides of the ridge portion of the first pixel electrode.

21. The liquid crystal display device of claim 17, wherein the first pixel electrode further comprises a side portion and a ridge portion perpendicularly extended from the side portion, and wherein each first pixel electrode stripe is extended from one of the side portion and the ridge portion such that each first pixel electrode stripe and the ridge portion define a first angle, α1, therebetween.

22. The liquid crystal display device of claim 21, wherein the second pixel electrode further comprises a side portion having a first end and a opposite, second end, a top portion and a bottom portion perpendicularly extended from the first and second ends, respectively, of the side portion that is aligned parallel to the side portion of the first pixel electrode, wherein each second pixel electrode stripe is extended from one of the side, top and bottom portions towards the ridge portion of the first pixel electrode such that each second pixel electrode stripe and the ridge portion of the first pixel electrode define a second angle, α2, therebetween, and wherein the second angle α2 is same as or substantially different from the first angle α1.

23. The liquid crystal display device of claim 22, wherein the side, top and bottom portions and the plurality of second pixel electrode stripes of the second pixel electrode, and the side portion and the plurality of first pixel electrode stripes of the first pixel electrode are placed symmetrically to the ridge portion of the first pixel electrode.

24. The liquid crystal display device of claim 17, wherein the width of each pitch varies continuously along the adjacent first pixel electrode and second pixel electrode stripes.

25. The liquid crystal display device of claim 17, wherein the width of each pitch varies discontinuously along the adjacent first pixel electrode and second pixel electrode stripes.

26. The liquid crystal display device of claim 17, wherein the width of each pitch is variable along the adjacent first pixel electrode and second pixel electrode stripes.

27. The liquid crystal display device of claim 17, wherein each pixel further comprises a counter electrode formed on the second substrate, and the counter electrode is electrically connected to the first pixel electrode, the second pixel electrode, an AC voltage or a DC voltage.

28. The liquid crystal display device of claim 17, further comprising a plurality of gate lines and signal lines electrically connected to the pixels correspondingly, wherein each first pixel electrode stripe and one of the gate lines form a first angle, α1.

29. The liquid crystal display device of claim 28, wherein each second pixel electrode stripe and the one of the gate lines form a second angle, α2, and wherein the second angle α2 is substantially different from the first angle α1.

30. The liquid crystal display device of claim 17, wherein each of the first and second pixel electrodes is divided into a first segment, a second segment, and a slant portion connected between the first segment and the second segment.
